(19) United States
(12) Patent Application Publication
(10) Pub. No.: US 2026/0032452 A1
(43) Pub. Date: Jan. 29, 2026

(54) OPERATIONS BETWEEN ACCESS POINTS WITH DIFFERENT CHANNEL CONFIGURATIONS

(71) Applicant: QUALCOMM Incorporated, San Diego, CA (US)

(72) Inventors: Sanket Sanjay KALAMKAR, San Diego, CA (US); Abhishek Pramod PATIL, San Diego, CA (US); Gaurang NAIK, San Diego, CA (US); Alfred ASTERJADHI, San Diego, CA (US); George CHERIAN, San Diego, CA (US); Sherief HELWA, San Diego, CA (US); Giovanni CHISCI, San Diego, CA (US); Sai Yiu Duncan HO, San Diego, CA (US)

(21) Appl. No.: 19/278,539

(22) Filed: Jul. 23, 2025

Related U.S. Application Data
(60) Provisional application No. 63/675,239, filed on Jul. 24, 2024.

(51) Int. Cl. H04W 16/10; H04L 5/00; H04W 28/02; H04W 74/00; H04W 74/0816

(52) U.S. Cl. CPC H04W 16/10; H04L 5/0053; H04W 28/0278; H04W 74/002; H04W 74/0816

(57) ABSTRACT

This disclosure provides methods, components, devices and systems for operations between access points with different channel configurations. Some aspects more specifically relate to coordination between access points for allocating transmission opportunities when the access points may use the same or different primary channels and/or operating bandwidths. In some examples, coordination may include exchanging coordination information for a transmission opportunity via a primary channel when two access points are configured to utilize the same primary channel. In some examples, coordination may include signaling to indicate the primary channel to be used by the first access point, the second access point, or both when the first access point and the second access point are configured to use different primary channels. The respective primary channels may be used to exchange transmission opportunity coordination information.

### CROSS-REFERENCE

The present application for patent claims benefit of U.S. Provisional Patent Application No. 63/675,239 by KALAMKAR et al., entitled “OPERATIONS BETWEEN ACCESS POINTS WITH DIFFERENT CHANNEL CONFIGURATIONS,” filed Jul. 24, 2024, assigned to the assignee hereof, and expressly incorporated herein.

### TECHNICAL FIELD

This disclosure relates generally to wireless communication and, more specifically, to operations between access points with different channel configurations.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

A method for wireless communications by a first access point is described. The method may include transmitting, to one or more second access points via a primary channel, a first coordination message including at least one of first information associated with coordination of resources of a transmission opportunity or second information associated with allocation of resources associated with the coordination, receiving, from a second access point of the one or more second access points, a second coordination message including third information associated with the coordination of or the allocation of the resources of the transmission opportunity, where the first information or the third information is communicated via the primary channel based on the first access point and the one or more second access points being configured to use a same primary channel, and communicating with one or more stations during at least a first portion of the transmission opportunity based on the allocation of the resources.

A first access point for wireless communications is described. The first access point may include a processing system that includes processor circuitry and memory circuitry that stores code. The processing system may be configured to cause the first access point to transmit, to one or more second access points via a primary channel, a first coordination message including at least one of first information associated with coordination of resources of a transmission opportunity or second information associated with allocation of resources associated with the coordination, receive, from a second access point of the one or more second access points, a second coordination message including third information associated with the coordination of or the allocation of the resources of the transmission opportunity, where the first information or the third information is communicated via the primary channel based on the first access point and the one or more second access points being configured to use a same primary channel, and communicate with one or more stations during at least a first portion of the transmission opportunity based on the allocation of the resources.

Another first access point for wireless communications is described. The first access point may include means for transmitting, to one or more second access points via a primary channel, a first coordination message including at least one of first information associated with coordination of resources of a transmission opportunity or second information associated with allocation of resources associated with the coordination, means for receiving, from a second access point of the one or more second access points, a second coordination message including third information associated with the coordination of or the allocation of the resources of the transmission opportunity, where the first information or the third information is communicated via the primary channel based on the first access point and the one or more second access points being configured to use a same primary channel, and means for communicating with one or more stations during at least a first portion of the transmission opportunity based on the allocation of the resources.

A non-transitory computer-readable medium storing code for wireless communications is described. The code may include instructions executable by one or more processors to transmit, to one or more second access points via a primary channel, a first coordination message including at least one of first information associated with coordination of resources of a transmission opportunity or second information associated with allocation of resources associated with the coordination, receive, from a second access point of the one or more second access points, a second coordination message including third information associated with the coordination of or the allocation of the resources of the transmission opportunity, where the first information or the third information is communicated via the primary channel based on the first access point and the one or more second access points being configured to use a same primary channel, and communicate with one or more stations during at least a first portion of the transmission opportunity based on the allocation of the resources.

A method for wireless communications by a first access point is described. The method may include receiving, from a second access point via a primary channel of the first access point, a first coordination message including at least one of first information associated with coordination of resources of a transmission opportunity or second information associated with allocation of resources associated with the coordination, transmitting, to the second access point, a second coordination message including third information associated with the coordination of or the allocation of the resources of the transmission opportunity, where the first information or the third information is communicated via the primary channel based on the first access point and the second access point being configured to use a same primary channel, and communicating with one or more stations during at least a first portion of the transmission opportunity based on the allocation of the resources.

A first access point for wireless communications is described. The first access point may include a processing system that includes processor circuitry and memory circuitry that stores code. The processing system may be configured to cause the first access point to receive, from a second access point via a primary channel of the first access point, a first coordination message including at least one of first information associated with coordination of resources of a transmission opportunity or second information associated with allocation of resources associated with the coordination, transmit, to the second access point, a second coordination message including third information associated with the coordination of or the allocation of the resources of the transmission opportunity, where the first information or the third information is communicated via the primary channel based on the first access point and the second access point being configured to use a same primary channel, and communicate with one or more stations during at least a first portion of the transmission opportunity based on the allocation of the resources.

Another first access point for wireless communications is described. The first access point may include means for receiving, from a second access point via a primary channel of the first access point, a first coordination message including at least one of first information associated with coordination of resources of a transmission opportunity or second information associated with allocation of resources associated with the coordination, means for transmitting, to the second access point, a second coordination message including third information associated with the coordination of or the allocation of the resources of the transmission opportunity, where the first information or the third information is communicated via the primary channel based on the first access point and the second access point being configured to use a same primary channel, and means for communicating with one or more stations during at least a first portion of the transmission opportunity based on the allocation of the resources.

A non-transitory computer-readable medium storing code for wireless communications is described. The code may include instructions executable by one or more processors to receive, from a second access point via a primary channel of the first access point, a first coordination message including at least one of first information associated with coordination of resources of a transmission opportunity or second information associated with allocation of resources associated with the coordination, transmit, to the second access point, a second coordination message including third information associated with the coordination of or the allocation of the resources of the transmission opportunity, where the first information or the third information is communicated via the primary channel based on the first access point and the second access point being configured to use a same primary channel, and communicate with one or more stations during at least a first portion of the transmission opportunity based on the allocation of the resources.

A method for wireless communications by a first access point is described. The method may include transmitting, to one or more second access points, a first coordination message including at least one of first information associated with coordination of resources of a transmission opportunity or second information associated with allocation of resources associated with the coordination, where the first coordination message includes an indication of a first primary channel of the first access point based on the first access point and a second access point of the one or more second access points being configured to use different primary channels, receiving, from the second access point of the one or more second access points, a second coordination message including third information associated with the coordination of or the allocation of the resources of the transmission opportunity, and communicating with one or more stations during at least a first portion of the transmission opportunity based on the allocation of the resources.

A first access point for wireless communications is described. The first access point may include a processing system that includes processor circuitry and memory circuitry that stores code. The processing system may be configured to cause the first access point to transmit, to one or more second access points, a first coordination message including at least one of first information associated with coordination of resources of a transmission opportunity or second information associated with allocation of resources associated with the coordination, where the first coordination message includes an indication of a first primary channel of the first access point based on the first access point and a second access point of the one or more second access points being configured to use different primary channels, receive, from the second access point of the one or more second access points, a second coordination message including third information associated with the coordination of or the allocation of the resources of the transmission opportunity, and communicate with one or more stations during at least a first portion of the transmission opportunity based on the allocation of the resources.

Another first access point for wireless communications is described. The first access point may include means for transmitting, to one or more second access points, a first coordination message including at least one of first information associated with coordination of resources of a transmission opportunity or second information associated with allocation of resources associated with the coordination, where the first coordination message includes an indication of a first primary channel of the first access point based on the first access point and a second access point of the one or more second access points being configured to use different primary channels, means for receiving, from the second access point of the one or more second access points, a second coordination message including third information associated with the coordination of or the allocation of the resources of the transmission opportunity, and means for communicating with one or more stations during at least a first portion of the transmission opportunity based on the allocation of the resources.

A non-transitory computer-readable medium storing code for wireless communications is described. The code may include instructions executable by one or more processors to transmit, to one or more second access points, a first coordination message including at least one of first information associated with coordination of resources of a transmission opportunity or second information associated with allocation of resources associated with the coordination, where the first coordination message includes an indication of a first primary channel of the first access point based on the first access point and a second access point of the one or more second access points being configured to use different primary channels, receive, from the second access point of the one or more second access points, a second coordination message including third information associated with the coordination of or the allocation of the resources of the transmission opportunity, and communicate with one or more stations during at least a first portion of the transmission opportunity based on the allocation of the resources.

A method for wireless communications by a first access point is described. The method may include receiving, from a second access point, a first coordination message including at least one of first information associated with coordination of resources of a transmission opportunity or second information associated with allocation of resources associated with the coordination, where the first coordination message includes an indication of a first primary channel of the first access point based on the first access point and the second access point being configured to use different primary channels, transmitting, to the second access point, a second coordination message including third information associated with the coordination of or the allocation of the resources of the transmission opportunity; and, and communicating with one or more stations during at least a first portion of the transmission opportunity based on the allocation of the resources.

A first access point for wireless communications is described. The first access point may include a processing system that includes processor circuitry and memory circuitry that stores code. The processing system may be configured to cause the first access point to receive, from a second access point, a first coordination message including at least one of first information associated with coordination of resources of a transmission opportunity or second information associated with allocation of resources associated with the coordination, where the first coordination message includes an indication of a first primary channel of the first access point based on the first access point and the second access point being configured to use different primary channels, transmit, to the second access point, a second coordination message including third information associated with the coordination of or the allocation of the resources of the transmission opportunity; and, and communicate with one or more stations during at least a first portion of the transmission opportunity based on the allocation of the resources.

Another first access point for wireless communications is described. The first access point may include means for receiving, from a second access point, a first coordination message including at least one of first information associated with coordination of resources of a transmission opportunity or second information associated with allocation of resources associated with the coordination, where the first coordination message includes an indication of a first primary channel of the first access point based on the first access point and the second access point being configured to use different primary channels, means for transmitting, to the second access point, a second coordination message including third information associated with the coordination of or the allocation of the resources of the transmission opportunity; and, and means for communicating with one or more stations during at least a first portion of the transmission opportunity based on the allocation of the resources.

A non-transitory computer-readable medium storing code for wireless communications is described. The code may include instructions executable by one or more processors to receive, from a second access point, a first coordination message including at least one of first information associated with coordination of resources of a transmission opportunity or second information associated with allocation of resources associated with the coordination, where the first coordination message includes an indication of a first primary channel of the first access point based on the first access point and the second access point being configured to use different primary channels, transmit, to the second access point, a second coordination message including third information associated with the coordination of or the allocation of the resources of the transmission opportunity; and, and communicate with one or more stations during at least a first portion of the transmission opportunity based on the allocation of the resources.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows a frequency diagram depicting an example distributed tone mapping.

FIG. 6 shows a pictorial diagram of another example wireless communication network.

FIG. 7 shows an example of a communication sequence that supports operations between access points with different channel configurations.

FIG. 8 shows examples of channel configurations that support operations between access points with different channel configurations.

FIG. 9 shows an example of a process flow that supports operations between access points with different channel configurations.

FIG. 10 shows a block diagram of an example wireless communication device that supports operations between access points with different channel configurations.

FIGS. 11 through 14 show flowcharts illustrating example processes performable by or at a first access point that supports operations between access points with different channel configurations.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, access points may coordinate communications using various coordinated access point (CAP) procedures, which may be used to allocate resources for communications with stations. For example, a coordinated time-division-multiple-access (C-TDMA) procedure may be used to allocate resources of a transmission opportunity (TXOP) between a sharing access point (e.g., the access point that initiates the procedure) and a shared access point (e.g., the access point that receives the resource allocation from the sharing access point). Moreover, access points may be configured to utilize primary channels (e.g., a subchannel of an operating bandwidth) for various control procedures. Utilization of primary channels may support reduction of resource overhead associated with monitoring of full channel bandwidths by access points and/or stations. However, access points may utilize different operating channels and/or different primary channels, which may be fully and/or partially overlapping.

Various aspects relate generally to coordination between access points for sharing transmission opportunities when the access points may use the same or different primary channels and/or operating bandwidths. Some aspects more specifically relate to, in the cases where access points are configured to use the same primary channel, coordination information being exchanged using the primary channel. The coordination information may include resource unit allocations, buffer status report trigger frames, subchannel mappings, among other information communications. Since the same primary channel is configured, the shared access point may be able to receive and understand the communications by the sharing access point. Some aspects more specifically relate to, if access points are permitted or configured to utilize different primary channels, signaling used to indicate the primary channel to be used by the sharing access point and/or the shared access point. The signaling may be in the form of a duplicate physical layer protocol data units (PPDUs) transmitted across various subchannels of an operating bandwidth such that candidate shared access points are able to receive the PPDU in their respective primary channel. Additional signaling may be used to indicate a shared access point's primary channel, communication to maintain control of entire bandwidth by a sharing access point, and puncturing pattern indications.

Particular aspects of the subject matter described in this disclosure can be implemented to realize one or more of the following potential advantages. In some examples, by communicating coordination information via a configured primary channel, the described techniques can be used by access points to coordinate transmission opportunities for communications by the access points with one or more stations. The coordination supports reduction in interference between the access point communications with the one or more stations. Additionally, coordination of communications via the primary channel may support a reduction in resource (e.g., processing, energy resources) utilization due to access points monitoring the primary channel rather than other portions of an operating bandwidth for coordination information. In some examples, by communicating an indication of a configured primary channel used by an access point, the described techniques can be used by access points to coordinate transmission opportunities for communications by the access points with one or more stations. The coordination supports reduction in interference between the access point communications with the one or more stations. Additionally, coordination of communications via the primary channel may support a reduction in resource (e.g., processing, energy resources) utilization due to access points monitoring the primary channel rather than other portions of an operating bandwidth for coordination information.

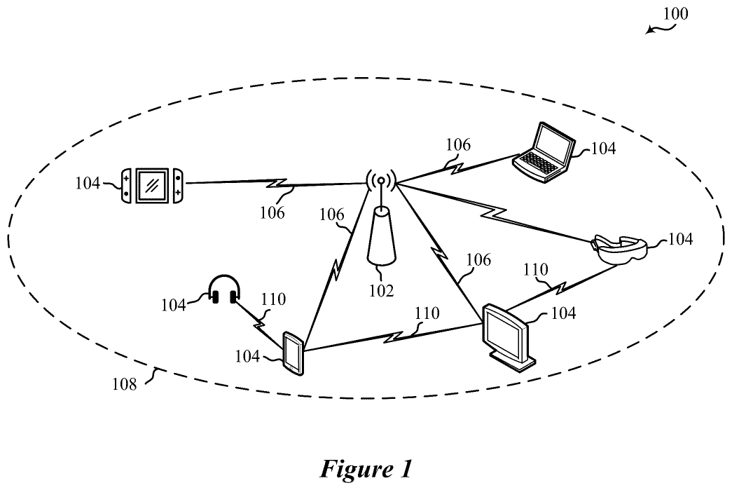

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IOT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHz, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHZ-52.6 GHZ), FR3 (7.125 GHZ-24.25 GHZ), FR4a or FR4-1 (52.6 GHZ-71 GHZ), FR4 (52.6 GHz-114.25 GHZ), and FR5 (114.25 GHZ-300 GHZ).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHZ, or 160 MHZ portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHZ, 160 MHZ, 240 MHZ, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

Puncturing is a wireless communication technique that enables a wireless communication device (such as either an AP 102 or a STA 104) to transmit and receive wireless communications over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as an AP 102 or a STA 104) may puncture the subchannels on which there is interference and in essence spread the data of the PPDU to cover the remaining portion of the bandwidth of the channel. For example, if a transmitting device determines (for example, detects, identifies, ascertains, or calculates), in association with a contention operation, that one or more 20 MHz subchannels of a wider bandwidth wireless channel are busy or otherwise not available, the transmitting device implement puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and Ultra-High Reliability (UHR) operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHZ, 40 MHz, 80 MHz, 160 MHz, 240 MHz, and 320 MHz while a UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHZ (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

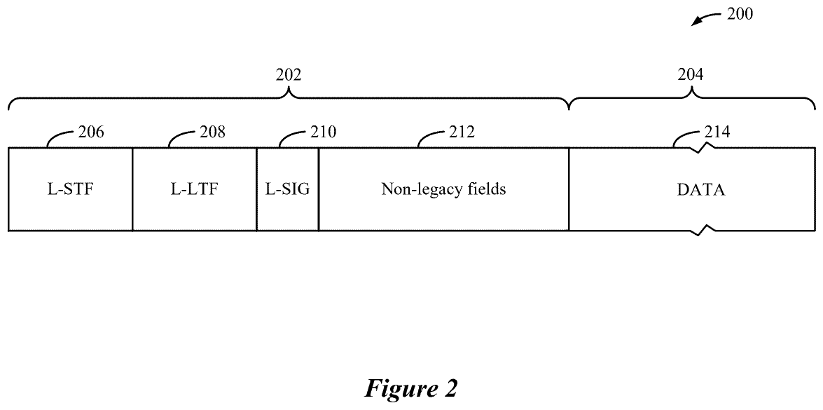

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

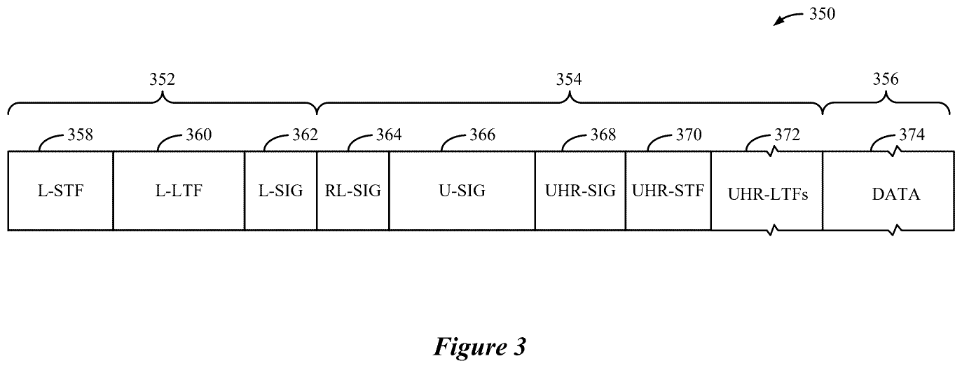

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364, a universal signal field 366 (referred to herein as “U-SIG 366”) and a UHR signal field 368 (referred to herein as “UHR-SIG 368”). The presence of RL-SIG 364 and U-SIG 366 may indicate to UHR or later version-compliant STAs 104 that the PPDU 350 is a UHR PPDU or a PPDU conforming to any later (post-UHR) version of a new wireless communication protocol conforming to a future IEEE 802.11 wireless communication protocol standard. One or both of U-SIG 366 and UHR-SIG 368 may be structured as, and carry version-dependent information for, other wireless communication protocol versions associated with amendments to the IEEE family of standards beyond UHR. For example, U-SIG 366 may be used by a receiving device (such as an AP 102 or a STA 104) to interpret bits in one or more of UHR-SIG 368 or the data field 374. U-SIG 366 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 366 and UHR-SIG 368 and additional information fields or single user (SU)-specific fields that may be useful to intended recipients. In some implementations, the version-dependent fields may include at least a PPDU format field to indicate a general PPDU format for the PPDU 350 (such as a trigger-based (TB), a single-user (SU), or a multi-user (MU) PPDU format). Like L-STF 358, L-LTF 360, and L-SIG 362, the information in U-SIG 366 and UHR-SIG 368 may be duplicated and transmitted in each of the component 20 MHz channels in instances involving the use of a bonded channel.

The non-legacy portion 354 further includes an additional short training field 370 (referred to herein as “UHR-STF 370,” although it may be structured as, and carry version-dependent information for, other wireless communication protocol versions beyond UHR) and one or more additional long training fields 372 (referred to herein as “UHR-LTFs 372,” although they may be structured as, and carry version-dependent information for, other wireless communication protocol versions beyond UHR). UHR-STF 370 may be used for timing and frequency tracking and AGC, and UHR-LTF 372 may be used for more refined channel estimation.

UHR-SIG 368 may be used by an AP 102 to identify and inform one or multiple STAs 104 that the AP 102 has scheduled uplink (UL) or downlink (DL) resources for them. UHR-SIG 368 may be decoded by each compatible STA 104 served by the AP 102. UHR-SIG 368 also may generally be used by the receiving device to interpret bits in the data field 374. For example, UHR-SIG 368 may include resource unit (RU) allocation information, spatial stream configuration information, and per-user (for example, STA-specific) signaling information. Each UHR-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some wireless communications systems, a STA 104 or an AP 102 may transmit the PPDU 350 over bandwidths larger than the 20 MHZ, 40 MHZ, 80 MHZ, 160 MHz, and 320 MHz bandwidths supported by previous generations of IEEE-compliant wireless communication systems. For example, the PPDU 350 may support 480 MHz or 640 MHz bandwidth communications. By increasing the channel bandwidth of the PPDU 350 to 480 MHz or 640 MHZ, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 370, UHR-LTFs 372, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range, a STA 104 and an AP 102 may support extended long range (ELR) PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 366 of an ELR PPDU 350 may include a first indication (for example, a codepoint of a PHY version identifier subfield within a version-independent portion of the U-SIG 366 or a value of an ELR subfield within a version-dependent portion of the U-SIG 366) that the PPDU 350 is associated with an ELR format. The U-SIG 366 of an ELR PPDU 350 may include a second indication (for example, a STA identifier subfield within the version-dependent portion of the U-SIG 366) of an intended receiver of the PPDU. In some examples, an ELR PPDU 350 may include an ELR-signature (ELR-SIG) field that includes an uplink/downlink indicator subfield, a length subfield, a coding indicator subfield, and a modulation and coding scheme (MCS) subfield.

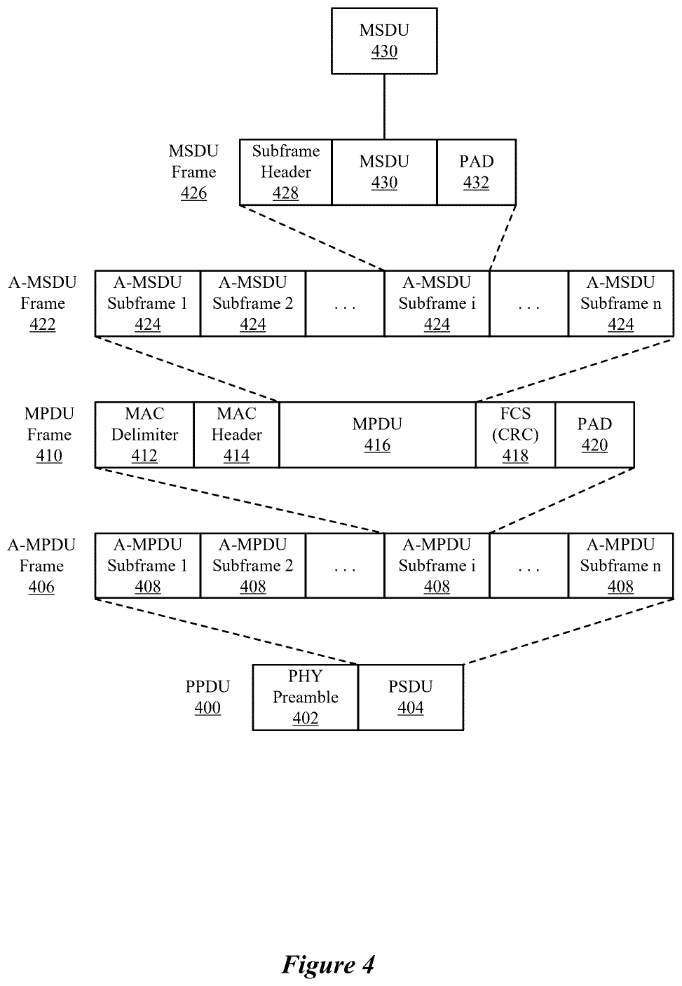

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 408 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (for example, the FCS field 418 may include a cyclic redundancy check (CRC)) and padding bits 420. The MPDU 416 may carry one or more MAC service data units (MSDUs) 430. For example, the MPDU 416 may carry an aggregated MSDU (A-MSDU) 422 including multiple A-MSDU subframes 424. Each A-MSDU subframe 424 may be associated with an MSDU frame 426 and may contain a corresponding MSDU 430 preceded by a subframe header 428 and, in some examples, followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body. The MAC header 414 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 414 also includes one or more fields indicating addresses for the data encapsulated within the frame body. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (for example, identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (for example, identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a TXOP and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (for example, the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (for example, the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or the STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (for example, the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

APs and STAs (for example, the AP 102 and the STAs 104 described with reference to FIG. 1) that include multiple antennas may support various diversity schemes. For example, spatial diversity may be used by one or both of a transmitting device (such as an AP 102 or a STA 104) or a receiving device (such as an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number N_{STS} of space-time streams, which are mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve an SNR, as well as in a multi-user (MU) context, for example, to enable MU-MIMO transmissions (also referred to as spatial division multiple access (SDMA)). In the MU-MIMO context, beamforming may additionally, or alternatively, involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (for example, in the form of a null data packet (NDP)) to the beamformee. An NDP is a PPDU without any data field. The beamformee may perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (for example, identify, detect, ascertain, calculate, or compute) how to transmit a signal on each of its antennas to perform beamforming. For example, the steering matrix may be indicative of a phase shift, or a power level, to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some examples, multiple APs 102 may simultaneously transmit signaling or communications to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

In some implementations, the AP 102 and STAs 104 can support various multi-user communications; that is, concurrent transmissions from one device to each of multiple devices (for example, multiple simultaneous downlink communications from an AP 102 to corresponding STAs 104), or concurrent transmissions from multiple devices to a single device (for example, multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHZ, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

In some wireless communications systems, an AP 102 may allocate or assign multiple RUs to a single STA 104 in an OFDMA transmission (hereinafter also referred to as “multi-RU aggregation”). Multi-RU aggregation, which facilitates puncturing and scheduling flexibility, may ultimately reduce latency. As increasing bandwidth is supported by emerging standards (such as the IEEE 802.11be standard amendment supporting 320 MHz and the IEEE 802.11bn standard amendment supporting 480 MHz and 640 MHz), various multiple RU (multi-RU) combinations may exist. Values indicating the various multi-RU combinations may be provided by a suitable standard specification (such as one or more of the IEEE 802.11 family of wireless communication protocol standards including the 802.11be standard amendment and the 802.11bn standard amendment).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing may be used in conjunction with multi-RU transmissions to enable wide channels to be established using non-contiguous spectrum blocks. In such examples, the portion of the bandwidth between two RUs allocated to a particular STA 104 may be punctured. Accordingly, spectrum efficiency and flexibility may be increased.

As described previously, STA-specific RU allocation information may be included in a signaling field (such as the UHR-SIG field for a UHR PPDU) of the PPDU's preamble. Preamble puncturing may enable wider bandwidth transmissions for increased throughput and spectral efficiency in the presence of interference from incumbent technologies and other wireless communication devices. Because RUs may be individually allocated in a MU PPDU, use of the MU PPDU format may indicate preamble puncturing for SU transmissions. While puncturing in the IEEE 802.11ax standard amendment was limited to OFDMA transmissions, the IEEE 802.11be standard amendment extended puncturing to SU transmissions. In some examples, the RU allocation information in the common field of UHR-SIG can be used to individually allocate RUs to the single user, thereby avoiding the punctured channels. In some other examples, U-SIG may be used to indicate SU preamble puncturing. For example, the SU preamble puncturing may be indicated by a value of the UHR-SIG compression field in U-SIG.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHZ, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (for example, one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (cMLMR) mode of operation, in which the MLD may be capable of dynamically switching radio resources (such as antennas or RF frontends) between multiple communication links (for example, switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (for example, monitor), transmit or receive on only a single communication link at any given time. An MLSR MLD may instead switch between different bands in a TDM manner.

In contrast, some MLSR MLDs may further be capable of an enhanced MLSR (cMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHZ band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

A wireless communication device may include an auxiliary radio and a main radio and may operate in both an auxiliary radio mode and a main radio mode. The wireless communication device may be a STA or an AP, such as, for example, the AP 102 and STAs 104 described with reference to FIG. 1. Additionally, the wireless communication device may support communications over a single wireless link or over multiple wireless links. For example, the wireless communication device may be an AP MLD or a non-AP MLD. The auxiliary radio mode may support communications with relatively lower data rates (such as ≤24 Mbps) than the main radio mode. For example, while operating in an auxiliary radio mode, the auxiliary radio of the wireless communication device may transmit messages having a non-high throughput (non-HT) format whereas, while operating in a main radio mode, the main radio may transmit messages having an EHT, UHR or later protocol format. A wireless communication device that uses an auxiliary radio in addition to a main radio may improve reliability and reduce latency and power consumption. For example, the wireless communication device may improve reliability by using the auxiliary radio to transmit/receive redundancies, facilitate fast feedback exchanges, or otherwise increase robustness for high-priority or otherwise important packets (for example, packets containing latency-sensitive traffic or traffic requiring high reliability). For example, to support latency-sensitive traffic insertion in uplink communications, an AP may utilize its auxiliary radio for detection of low latency PPDU (LL-PPDU) subframes associated with latency-sensitive traffic. As another example, the wireless communication device also may use the auxiliary radio to scan for channels while communicating on another channel via the main radio, thereby reducing latency associated with a transition between channels by eliminating the time for the main radio to scan for channels. As another example, use of the auxiliary radio may reduce power consumption by enabling the main radio to enter a sleep mode and monitoring for wake-up signals via the auxiliary radio, which is designed to consume less power than the main radio.

The auxiliary radio may support both transmitting and receiving (Tx/Rx) modes of operation, or may support receiving-only (Rx-only) modes of operation. If the wireless communication device is an MLD, the wireless communication device may communicate on one or more wireless links using a main radio and may simultaneously communicate on one or more wireless links using one or more auxiliary radios. In an MLD scenario in which the auxiliary radio is Rx-only capable (an “Aux-Rx” mode), the wireless communication device may transmit and receive communications on a first wireless link using the main radio but may simultaneously receive (but not transmit) communications on a second wireless link using the auxiliary radio. In an MLD scenario in which the auxiliary radio is Tx/Rx capable (an “Aux-Tx/Rx” mode), the wireless communication device may transmit and receive communications on a first wireless link using the main radio and may simultaneously transmit and receive communications on a second wireless link using the auxiliary radio. In an MLD scenario, the wireless communication device may transition the main radio from a second wireless link to a first wireless link and may correspondingly transition the auxiliary radio from the first wireless link to the second wireless link. For example, the wireless communication device's auxiliary radio may receive control signaling on the second wireless link from another wireless communication device that triggers the wireless communication device to switch the use of its radios between wireless links. If the wireless communication device is not an MLD, the wireless communication device may transition from using its auxiliary radio to using its main radio mode on a single wireless link. For example, the wireless communication device's auxiliary radio may receive control signaling from another wireless communication device that triggers the wireless communication device to initiate the transition from use of the auxiliary radio to the main radio on the wireless link. Upon such a transition, the wireless communication device may place the auxiliary radio in a powered-down sleep state while activating the main radio to an awake state. Similarly, the wireless communication may transition from using its main radio to its auxiliary radio on the wireless link upon receiving a triggering control signal.

In some examples, the wireless communication device (such as a STA) may indicate (for example, via a broadcast frame such as a beacon frame or other management frame), to other wireless communication devices (such as an AP), parameters associated with an auxiliary radio mode or parameters associated with transitioning from the auxiliary radio mode to a main radio mode for a given wireless link. For example, the wireless communication device may indicate a message format for the auxiliary radio mode. The indicated message format may be associated with a particular PPDU format (such as non-HT) or a supported data rate (such as ≤24 Mbps).

In some examples, the wireless communication device may indicate transition delays corresponding to time durations associated with switching from the auxiliary mode to the main radio mode as well as switching from the main radio mode to the auxiliary radio mode for a wireless link. A second wireless communication device may schedule data communications with the wireless communication device based on the transition delay so that data is not transmitted to the wireless communication device during the transition delay, during which data may be lost. The duration of the transition delay may generally be dependent on whether the auxiliary radio supports Tx/Rx or Rx-only modes of operation. For example, if the auxiliary radio supports Tx/Rx, the auxiliary radio may transmit an acknowledgment message in response to a request to transition to the main radio mode for a wireless link, which may extend the transition delay. Additionally, or alternatively, the duration of the transition delay may depend on whether the main radio is transitioning from a sleep mode or from a different wireless link.

The auxiliary radio may perform additional functions while the wireless communication device communicates with a second wireless communication device via a wireless link using the main radio. The functions that may be performed may generally depend on whether the auxiliary radio supports Tx/Rx or Rx-only modes of operation or whether the wireless communication device is an MLD capable of supporting communications over more than one wireless link. For example, in an Aux-Rx mode, the auxiliary radio of a wireless communication device (such as a non-AP MLD) may monitor or collect channel state (or quality) information or statistics (such as BSS load, interference profiles of neighboring BSSs and multi-NAV multi-primary maintenance) in a passive manner. In an Aux Tx/Rx mode, the auxiliary radio of the non-AP MLD may monitor or collect channel state information or statistics as well as transmit a report to an AP MLD that includes the collected channel state information or statistics without involvement of the main radio. In some examples, while operating in an Aux-Rx mode, a first wireless communication device (such as an AP MLD) may use the auxiliary radio to receive control communications or high-priority or otherwise important data communications from the second wireless communication device (such as another AP MLD) using a second wireless link while its main radio uses the first wireless link to perform data transfer. In contrast, in an Aux-Tx/Rx mode, an AP MLD may use the auxiliary radio to both receive and transmit control communications or high-priority or otherwise important data communications. In some examples, while operating in an Aux-Rx mode, a non-AP MLD's auxiliary radio may monitor or scan for potential APs to associate with on alternative wireless channels than the wireless channel on which the non-AP MLD's main radio is still communicating with a previously connected AP. In an Aux-Tx/Rx mode, an MLD may use the auxiliary radio to both scan for and perform association or authentication on other wireless channels.

In some environments, locations, or conditions, a regulatory body may impose a power spectral density (PSD) limit for one or more communication channels or for an entire band (for example, the 6 GHz band). A PSD is a measure of transmit power as a function of a unit bandwidth (such as per 1 MHZ). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of a wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (for example, duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

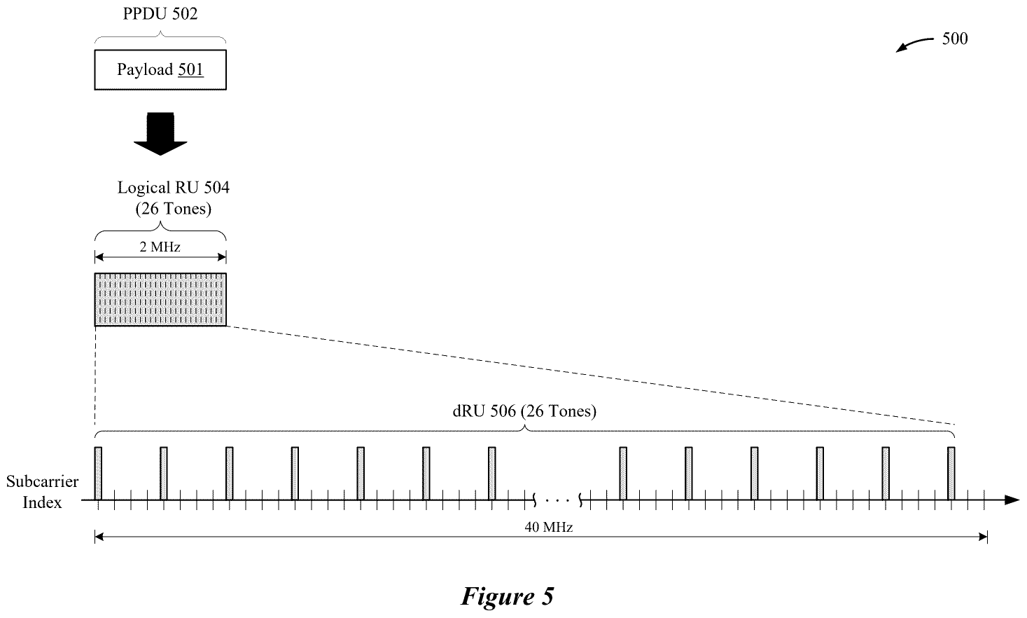

FIG. 5 shows a frequency diagram 500 depicting an example distributed tone mapping. More specifically, FIG. 5 shows an example mapping of how the tones of a payload 501 of a PPDU 502 are distributed for transmission over a spreading bandwidth of a wireless channel. In the illustrated example, the tones in a logical RU 504 (which may represent an rRU of non-distributed tones in accordance with a legacy tone plan) associated with payload 501 are mapped to a distributed RU (dRU) 506 in accordance with a distributed tone plan.

Aspects of the present disclosure recognize that by distributing the tones across a wider bandwidth, the per-tone transmit power of a logical RU 504 may be increased to provide greater flexibility in medium utilization for PSD-limited wireless channels. For example, when mapped to an rRU such as logical RU 504, the transmit power of the logical RU 504 may be severely limited based on the PSD of the wireless channel. For example, the LPI power class limits the transmit power of APs 102 and STAs 104 to 5 dBm/MHz and −1 dBm/MHz, respectively, in the 6 GHz band. As such, the per-tone transmit power of the logical RU 504 is limited by the number of tones mapped to each 1 MHz subchannel of the wireless channel.

By enabling a STA 104 to map modulation symbols in a distributed manner onto noncontiguous tones interspersed throughout all or a portion of a wireless channel, distributed transmissions may enable an increase in the per-tone transmit power used for each individual distributed tone, and thus the overall transmit power of the PPDU 502, without exceeding the PSD limits of the wireless channel. As shown in the example of FIG. 5, the STA 104 may map logical RU 504 to a set of 26 noncontiguous subcarrier indices spread across a 40 MHz wireless channel (also referred to herein as a “spreading bandwidth”). Compared to the tone mapping described above with respect to the legacy tone plan, the distributed tone mapping depicted in FIG. 5 effectively reduces the number of tones (of the logical RU 504) in each 1 MHz subchannel. For example, each of the 26 tones can be mapped to a different 1 MHz subchannel of the 40 MHz channel. As a result, each AP 102 or STA 104 implementing the distributed tone mapping of FIG. 5 can maximize its per-tone transmit power (which may maximize the overall transmit power of the logical RU 504).

In some examples (not shown in FIG. 5), multiple logical RUs may be mapped to interleaved subcarrier indices of a shared wireless channel. For example, a STA 104 may modulate a portion of the symbols on a number of tones representing multiple logical RUs to noncontiguous subcarrier indices associated with a shared wireless channel in accordance with a distributed tone plan. Furthermore, distributed transmissions by multiple STAs 104 may be multiplexed onto different sets of distributed tones of a shared wireless channel such as to enable an increase in the transmit power of each device without sacrificing spectral efficiency. Such increases in transmit power can be combined with some MCSs to increase the range and throughput of wireless communications on PSD-limited wireless channels. Distributed transmissions also may improve packet detection and channel estimation capabilities.

To support distributed transmissions, new packet designs and signaling may be used to indicate whether a PPDU 502 is transmitted on tones spanning an rRU, such as a logical RU 504 (according to a legacy tone plan), or a dRU 506 (according to a distributed tone plan). For example, the IEEE 802.11be standard amendment or earlier versions of the IEEE 802.11 family of wireless communication protocol standards define a trigger frame format which can be used to solicit the transmission of a trigger-based (TB) PPDU from one or more STAs 104. The trigger frame allocates resources to the STAs 104 for the transmission of the TB PPDU and indicates how the TB PPDU is to be configured for transmission. For example, the trigger frame may indicate a logical RU or MRU allocated for transmission in the TB PDDU. In some examples, the trigger frame may be further configured to carry tone distribution information indicating whether the logical RU (or MRU) maps to an rRU or a dRU.

In some implementations, a STA 104 may include a distributed tone mapper that maps the logical RU 504 to the dRU 506 in the frequency domain. The dRU 506 is converted to a time-domain signal (such as by an inverse fast Fourier transform (IFFT)) for transmission over a wireless channel. The AP 102 may receive the time-domain signal and reconstruct the dRU 506 (such as by a fast Fourier transform (FFT)). In some implementations, the AP 102 may include a distributed tone demapper that demaps the dRU 506 to the logical RU 504. In other words, the distributed tone demapper reverses the mapping performed by the distributed tone mapper at the STA 104. The AP 102 can recover the information carried (or modulated) on the logical RU 504 as a result of the demapping.

In the example of FIG. 5, the logical RU 504 is distributed evenly across the spreading bandwidth. While the example shown in FIG. 5 illustrates a spreading bandwidth of 40 MHz, spreading bandwidths also may include 80 MHz, 160 MHz, or 320 MHz. In some implementations, the logical RU 504 can be mapped to any suitable pattern of noncontiguous subcarrier indices. For example, in various implementations, the distance between any pair of adjacent modulated tones may be less than or greater than the distances depicted in FIG. 5.

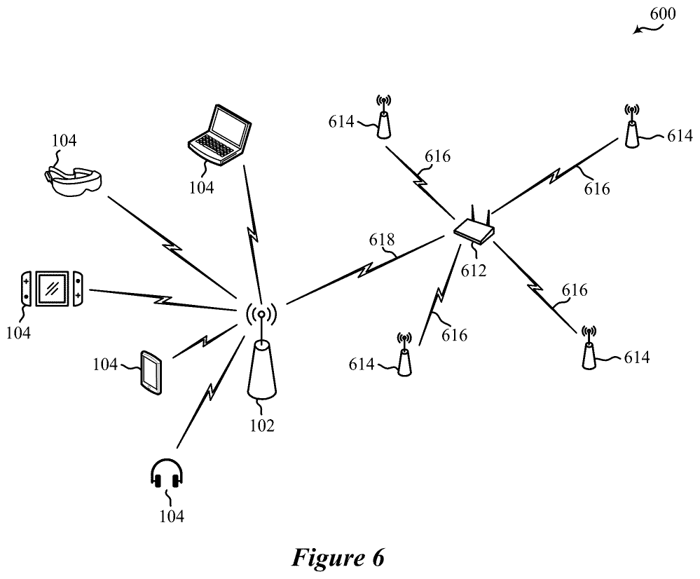

FIG. 6 shows a pictorial diagram of another example wireless communication network 600. According to some aspects, the wireless communication network 600 can be an example of a mesh network, an IoT network, or a sensor network in accordance with one or more of the IEEE 802.11 family of wireless communication protocol standards (including the 802.11ah amendment). The wireless communication network 600 may include multiple wireless communication devices 614, which in some implementations may include APs 102, STAs 104, or both. The wireless communication devices 614 may represent various devices such as display devices (for example, TVs, computer monitors, navigation systems, among others), music or other audio or stereo devices, remote control devices (“remotes”), printers, kitchen or other household appliances, among other examples.

In some examples, the wireless communication devices 614 sense, measure, collect or otherwise obtain and process data and transmit such raw or processed data to an intermediate device 612 for subsequent processing or distribution. Additionally, or alternatively, the intermediate device 612 may transmit control information, digital content (for example, audio or video data), configuration information or other instructions to the wireless communication devices 614. The intermediate device 612 and the wireless communication devices 614 can communicate with one another via wireless communication links 616. In some examples, the wireless communication links 616 include Bluetooth links or other PAN or short-range communication links.

In some examples, the intermediate device 612 also may be configured for wireless communication with other networks such as with a WLAN or a wireless (for example, cellular) wide area network (WWAN), which may, in turn, provide access to external networks including the Internet. For example, the intermediate device 612 may associate and communicate, over a Wi-Fi link 618, with an AP 102 of a wireless communication network 600, which also may serve various STAs 104. In some examples, the intermediate device 612 is an example of a network gateway, for example, an IoT gateway. In such a manner, the intermediate device 612 may serve as an edge network bridge providing a Wi-Fi core backhaul for the IoT network including the wireless communication devices 614. In some examples, the intermediate device 612 can analyze, preprocess and aggregate data received from the wireless communication devices 614 locally at the edge before transmitting it to other devices or external networks via the Wi-Fi link 618. The intermediate device 612 also can provide additional security for the IoT network and the data it transports.

Aspects of transmissions may vary according to a distance between a transmitter (for example, an AP 102 or a STA 104) and a receiver (for example, another AP 102 or STA 104). Wireless communication devices (such as the AP 102 or the STA 104) may generally benefit from having information regarding the location or proximities of the various STAs 104 within the coverage area. In some examples, relevant distances may be determined (for example, calculated or computed) using RTT-based ranging procedures. Additionally, in some examples, APs 102 and STAs 104 may perform ranging operations. Each ranging operation may involve an exchange of fine timing measurement (FTM) frames (such as those defined in the 802.11az amendment to the IEEE family of wireless communication protocol standards) to obtain measurements of RTT transmissions between the wireless communication devices.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

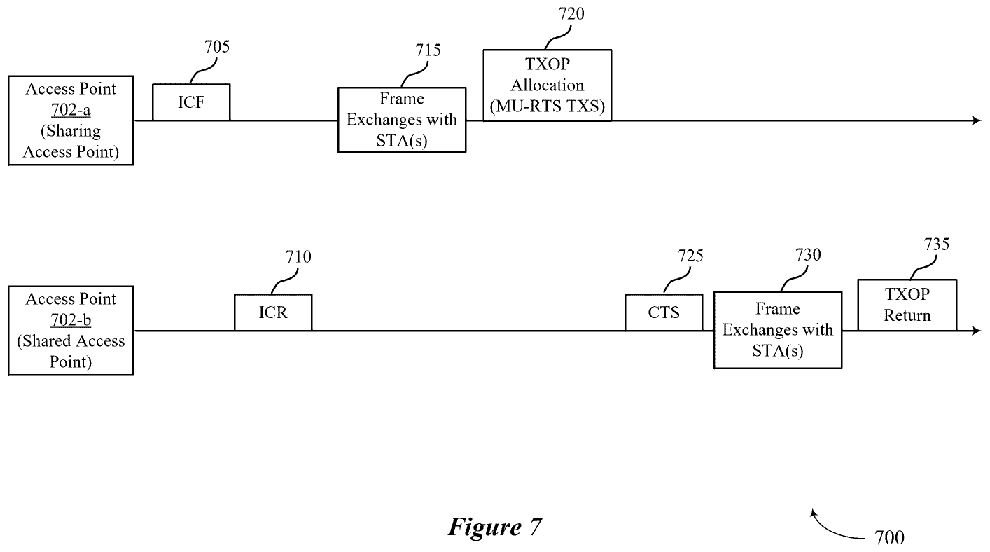

FIG. 7 shows an example of a communication sequence 700 that supports operations between access points with different channel configurations. The communication sequence 700 illustrates example operations between APs 702 in accordance with an example CAP procedure. The APs 702 may be examples of the APs described with respect to FIGS. 1 through 7. The CAP procedure illustrated in the communication sequence 700 is a C-TDMA procedure. However, it should be understood that the techniques described herein may be applicable to other types of CAP procedures. Other CAP procedures may include coordinated restricted target wake time (R-TWT), coordinated spatial reuse, coordinated beamforming, etc. Thus, the resources of a transmission opportunity that are allocated in accordance with the coordination messaging described herein may include time domain resources, frequency domain resources, spatial resources, beamforming resources, or any combination thereof. In accordance with the C-TDMA procedure, the AP 702-a may be referred to as the sharing access point, and the AP 702-b may be referred to as the shared access point.

At 705, the AP 702-a may transmit information via a control frame, such as an initial control frame (ICF). The ICF may function as a polling and/or a scheduling announcement frame, and may solicit responses from one or more other APs, such as AP 702-b and/or one or more STAs, such as the STAs participating in frame exchanges during at 715. For example, the ICF may function as a polling frame in that it includes information to poll other APs on whether the other APs are willing to participate in the CAP, such as the C-TDMA procedure. Additionally, or alternatively, the ICF may function as a scheduling announcement frame in that includes information that schedules resources for a TXOP, such as a TXOP at 730. In some examples, the ICF announces the schedule for the CAP, such as the schedule for the C-TDMA procedure. For example, the ICF may include information that indicates the resources during which the TXOP allocation (e.g., at 720) is to be transmitted. In response to the ICF at 705, other APs, such as AP 702-b, may transmit information in an initial control response (ICR) frame, and the information may indicate whether the AP is to participate in the procedure. The response (e.g., ICR) could be a Buffer Status Report (or a variant thereof designed for coordinated AP operation), a Clear To Send (CTS), a multi-STA blockack (M-BA) carrying buffer status or resource request information, or a public action management frame carrying buffer status or resource request information. If it is an M-BA, a new combination of AID11 and TID values in a field (e.g., a Per AID TID information field) can be used to indicate that the field is carrying buffer status information or resource request information of the responding AP.

At 715, the AP 702-a may communicate with one or more STAs using a communication frame. The communication frame may be based on information included in the ICF at 705. At 720, the AP 702-a may transmit information in a TXOP allocation frame, which may indicate resource units (RUs) and/or subchannels via which the APs are to communicate in accordance with the procedure. At 725, one or more APs, such as the AP 702-b, may transmit a response message (e.g., a CTS message). The response message may be transmitted in response to the TXOP application frame. At 730, the AP 702-b may communicate with one or more STAs during resources (e.g., resources of a TXOP), such as resources allocated via the TXOP allocation frame. At 735, the AP 702-b may transmit a TXOP return message at 735, which may release a portion of the resources of the transmission opportunity. The TXOP return message can be in the form of Command And Status (CAS) Control field carried in a frame which could be a public action management frame, a quality of service (QOS) Null frame or an M-BA. When the primaries are not the same, the TXOP return frame be carried in a non-HT duplicate PPDU format.

To support efficient C-TDMA operation (or other types of CAP operations), the sharing AP (e.g., the AP 702-a) and candidate shared APs (e.g., the AP 702-b) may communicate with each other. For example, ICF/ICR exchanges between the sharing AP and candidate shared APs are used to facilitate polling/schedule announcement procedures. For example, the ICF from the sharing AP may inform over what subchannels or resource units (RUs) the TXOP sharing is to occur or via what subchannels or RUs a response from the shared AP is to be communicated. In some cases, the ICR from a candidate shared AP informs whether a candidate shared AP is to participate in TXOP sharing in the current TXOP. In some cases, the shared AP is to correctly receive the TXOP allocation frame from the sharing AP. The procedure supports the shared AP accurately determining the allocated subchannel/RU. Additionally, the procedure may support the sharing AP correctly receiving the TXOP return frame from the shared AP. To receive such coordination related critical frame exchanges between the sharing AP and candidate shared APs, the receiving AP is to receive the frames in a primary channel of the receiving AP. For example, the (candidate) shared APs are to receive the ICF and the TXOP Allocation frame in the (candidate) shared AP's primary channel. Additionally, the primary channel of the receiving AP is to be within the operating channel configurations of the transmitting AP.

In some examples, aspects of the communication sequence 700 may be optional. For example, a first communication in the communication sequence 700 may be the TXOP allocation at 720, such that an initial polling frame (ICF) is not transmitted and the ICR is not transmitted. As described herein, the TXOP allocation may be indicative of the primary channel of the AP 702-a (when the AP 702-a and the AP 702-b are configured or permitted to use different primary channels), and/or the TXOP allocation may be transmitted via the primary channel of the AP 702-a and the AP 702-b (when the AP 702-a and the AP 702-b are configured to use the same primary channel).

Additionally, the various transmissions of the communication sequence 700 may include different information, depending on the context of the communication sequence. For example, a control frame that is transmitted (e.g., the ICF at 705 or a transmission at 720) may trigger a TB-PPDU response by one or more access points, such as the AP 702-b. Such a transmission may include a BSRP trigger frame. Additionally, or alternatively, a transmitted control frame may not solicit a TB-PPDU response by one or more access points. Such a transmission may include a MU-RTS frame or a multi-user block acknowledgement (ACK) request (MU-BAR) frame. In some examples, a response may include the information described herein with reference to the ICR at 705.

As described herein, the communication sequence 700 may function to coordinate the transmission opportunity for one or more access points, including the AP 702-a and the AP 702-b. During at least a first portion of a transmission opportunity (e.g., a portion allocated to the AP 702-a), the AP 702-a may communicate with one or more STAs associated with the AP 702-a, one or more STAs associated with the AP 702-b, or both. Additionally, or alternatively, during at least a second portion of the transmission opportunity (e.g., a portion allocated to the AP 702-b), the AP 702-b may communicate with one or more STAs associated with the AP 702-b, one or more STAs associated with the AP 702-a, or both.

The transmission opportunity may be allocated with a target wait time (TWT) service period (SP) (e.g., TWT-SP) that is configured by the first AP 702-a. In some cases, the TWT schedule may be an example of a restricted (TWT-SP) (rTWT-SP) that is coordinated by the first AP 702-a with the second AP 702-b.

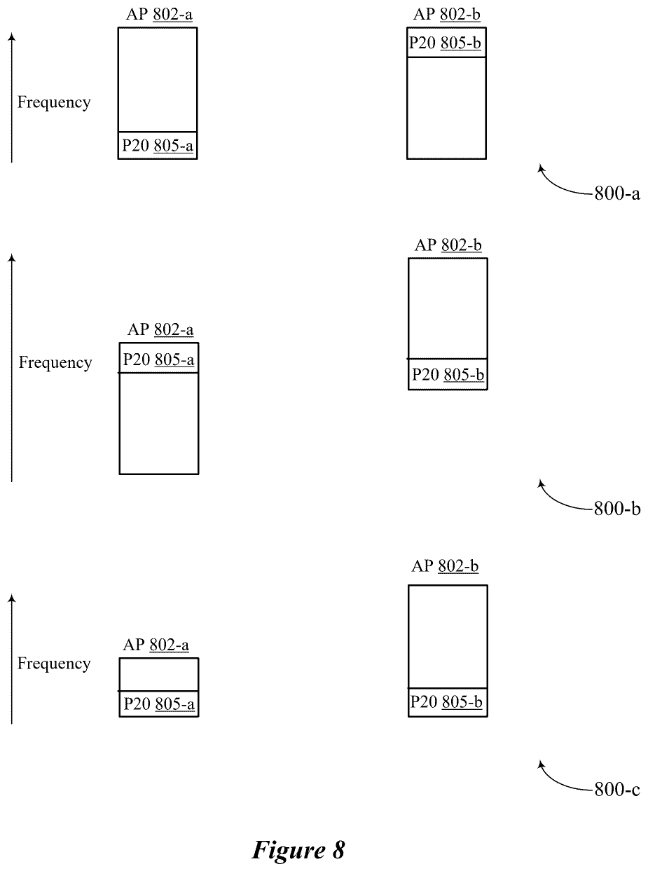

FIG. 8 shows examples of channel configurations 800 that support operations between access points with different channel configurations. The channel configurations 800 illustrate example configurations of an operating bandwidth and a primary channel 805 that are used by an AP 802-a and an AP 802-b, which may be examples of the APs described herein with reference to FIGS. 1 through 8. Each primary channel may be configured as a 20 MHz channel, which is why the primary channel may be referred to as P20 (primary 20 MHZ). It should be understood the techniques described herein may be applicable to different bandwidth primary channels or different channel configurations from those illustrated in FIG. 8. The AP 802-a may be an example of a sharing AP, and the AP 802-b may be an example of a shared AP in accordance with a CAP procedure (e.g., C-TDMA). Additionally, or alternatively, the AP 802-a may be an example of a shared AP, and the AP 802-b may be an example of a sharing AP in accordance with a CAP procedure.

As illustrated in FIG. 8, the sharing and the shared APs 802 may have different primary channels and basic service set (BSS) operating bandwidths. In the case of the same operating bandwidths, the bandwidths may be fully overlapping (e.g., as in channel configuration 800-a) or partially overlapping (e.g., as in channel configuration 800-b). In cases of different operating bandwidths, the operating bandwidths of one AP may be a subset of the bandwidth of another AP, as illustrated in channel configuration 800-c.

Techniques described herein support CAP procedures for APs with different operating bandwidths as well as different primary channels (e.g., 20 MHz channels). For example, different options are described herein to support C-TDMA operation (and other CAP operations) between participating APs having different configurations (e.g., operating bandwidths or 20 MHz channels). For example, techniques described herein support indications of the primary channel if the primary channels are different between APs. Additionally, the techniques support a sharing AP maintaining control of unused portions of the operating bandwidth if the shared AP does not utilize the full operating bandwidth.

In some cases, the sharing and shared APs may be configured to utilize the same primary channel (e.g., the same 20 MHz radio-frequency band). In such cases, the APs may exchange coordination related information via the common primary channel. For example, the candidate shared AP may understand the RU allocation by the sharing AP if the ICF that results in a PPDU response (e.g., a trigger-based PPDU (TB PPDU)) is transmitted via the primary channel to the shared AP. For example, transmission of a buffer status report (BSRP) trigger frame may result in a TB PPDU response. As such, the BSRP trigger frame may be transmitted via at least the primary channel. Additionally, the candidate shared AP may receive a multi-user (MU) request to send (RTS) message that includes a subchannel mapping from the sharing AP. In such cases, the MU-RTS (e.g., as an ICF) may be transmitted via at least the primary channel such that the candidate shared access point is able to receive the MU-RTS including the subchannel mapping.

In some cases, the sharing and the shared access points may have the same primary channel but different operating channel bandwidths. In such cases, the TXOP sharing (e.g., coordination of TXOP resources) may be allocated on the overlapping portion of the respective operating bandwidths. Additionally, the sharing AP may perform operations or communications on the non-overlapping (e.g., unoccupied) portion of the operating bandwidth to limit or prevent other APs or stations from occupying those portions of the operating bandwidth. For example, the sharing AP may perform dynamic subband operation (DSO) or non-primary channel access (NPCA) communications to occupy the non-overlapping bandwidth. Using these techniques, the sharing AP may maintain control of the operating bandwidth of the sharing AP, even if the shared AP does not utilize a portion of the operating bandwidth of the sharing AP. Thus, the sharing AP may use the entire operating bandwidth of the sharing AP after a TXOP return from the shared AP.

Additionally, or alternatively, the sharing and the shared APs may be permitted to or configured to use different primary channels. In such cases, for CAP procedures to function, the primary channel of a receiving AP (e.g., a shared AP) may be configured or designed to be within the operating channel bandwidth of the transmitting AP (e.g., the sharing AP). With different primary channels, participating access points may be provided information indicative of the primary channel utilized by the other APs such as to allow coordination of resources. In accordance with a first option, the sharing AP may share an indication of the primary channel used by the sharing AP via the soliciting ICF (e.g., the ICF transmitted at 705 in FIG. 7). In accordance with a second option, the sharing AP may share an indication of the primary channel used by the sharing AP during the CAP or C-TDMA negotiations. In either of these cases, when the APs are permitted to use different primary 20 MHz channels the indication of the primary channel (e.g., the ICF), the TXOP return frame, or both, may be configured to be transmitted in non-HT duplicate PPDU format so that the frame is duplicated on multiple subchannels of the operating bandwidth such that the receiving (shared) AP is able to receive the information, such as the primary channel indication in the ICF and the TXOP return frame. For example, in channel configuration 800-a, the AP 802-a transmits the ICF with the primary channel indication of the primary channel 805-a via duplicate PPDU formats via each 20 MHz block of the operating bandwidth. As such, the AP 802-b may receive the ICF via the primary channel 805-b of the AP 802-b. Additionally, the AP 802-b may transmit the TXOP return frame via each 20 MHz portion of the operating bandwidth of the AP 802-b such that the TXOP return frame is received at the AP 802-a via the primary channel 805-a of the AP 802-a. Allowing APs to use different primary channels may support improved flexibility relative to the scenario in which the APs have the same primary channel. Additionally, different primary channels may support occurrence of AP contentions on different 20 MHz subchannels.

As described herein, the indication of the primary channel (e.g., when the primary channels are different) may be shared via the soliciting ICF (e.g., the polling/schedule announcement frame) such that the sharing AP may inform a candidate shared AP the primary channel location (e.g., bandwidth), the RU allocated that the sharing AP uses, and/or the MU-RTS subchannel mapping. The (candidate) shared AP may use this information to provide the response to the polling/schedule announcement frame in a configured RU (e.g., assigned by the sharing AP) or subchannel. The shared AP may additionally use the received information to transmit the TXOP return frame in the primary channel of the sharing AP (e.g., the primary channel 805-a of the AP 802-a). Additionally, to increase the probability that the shared AP receives the ICF, the sharing AP may transmit the ICF in a non-HT duplicate PPDU format in channels across the operating bandwidth of the sharing AP such that the non-HT duplicate PPDU is received via the primary channel of the receiver (e.g., the shared AP). Moreover, the shared AP may respond to the ICF (e.g., via ICR at 710) with an indication of the primary channel used by the shared AP. For example, the AP 802-a may transmit the ICF with the indication of the primary channel 805-a, and the AP 802-b may respond to the ICF with the indication of the primary channel 805-b. Additionally, or alternatively, the sharing AP may indicate that the sharing AP has information regarding the shared AP's primary channel in the soliciting ICF. For example, the AP 802-a may transmit the ICF with the indication of the primary channel 805-a of the sharing AP and an indication of the primary channel 805-b of the shared AP.

The indication of the primary channel may also be transmitted via CAP signaling. For example, a non-HT duplicate PDU transmitted via a dedicated CAP broadcast frame (such as a CAP advertisement frame). Thus, as described with respect to the ICF, the other APs may identify the primary channel of the transmitting AP by listening on their own respective primary channels. In some examples, the APs may advertise their primary channels and the respective operating classes (e.g., UHR capabilities) in the dedicated CAP broadcast frame. Thus, using this information, the APs can identify the primary channels as well as the overlapping bandwidths, which may correspond to the operating class or UHR capabilities. Accordingly, the APs 802 may be configured to utilize a broadcasting AP frame for transmission of a non-HT duplicate PPDU format that includes the primary channel indication and/or the UHR capability.

As described herein, the sharing AP may indicate an RU for various APs in the ICF or another allocation communication. That is, the sharing AP may allocate, to each candidate shared AP, a respective RU or subchannel. Each RU or subchannel allocation may be made with reference to (e.g., offset from) the sharing AP's primary 20 MHz channel bandwidth. That is, the ICF (or another communication frame) may indicate the primary channel and the RU or subchannel offset, and the receiving or shared AP may determine the RU or subchannel based on the offset and the sharing AP's primary channel. Additionally, or alternatively, the RU or subchannel may be indicated relative to the receiving AP's primary channel. Thus, the ICF may indicate the offset and the receiving AP may determine the RU or subchannel based on the receiving AP's primary channel and the indicated offset. In some examples, the sharing AP may account for the shared AP's bandwidth when allocating a RU or subchannel in the CAP ICF. For example, the RU or subchannel allocated to a shared AP is not to be allocated outside the shared AP's operating bandwidth. Thus, the coordination information exchanged between the APs may include operating bandwidth information such that the sharing AP is able to sufficiently allocate RUs or subchannels.

Additionally, when sharing coordination messages, the APs 802 may indicate, via CAP signaling, ICF, or ICR, the static puncturing patterns for communications with one or more STAs. If the sharing AP indicates the puncturing pattern that the sharing AP intends to utilize in communications with one or more STAs, then the shared AP may apply the same puncturing pattern with the TXOP sharing bandwidth as that of the sharing AP, or the shared AP may not apply the puncturing pattern. In the case that the shared AP does not apply the sharing AP's puncturing pattern, the shared AP may determine whether the allocated and punctured channel is usable. In some examples, the sharing AP does not provide the puncturing patterns (since the pattern applies to the BSS based on conditions in the sharing AP's coverage area). In such cases, if the static puncturing pattern of the sharing AP is not known at the shared AP, the shared AP may use the TXOP sharing bandwidth based on shared AP's bandwidth analysis. That is, the shared AP may use a puncturing pattern determined by the shared AP within the TXOP sharing bandwidth.

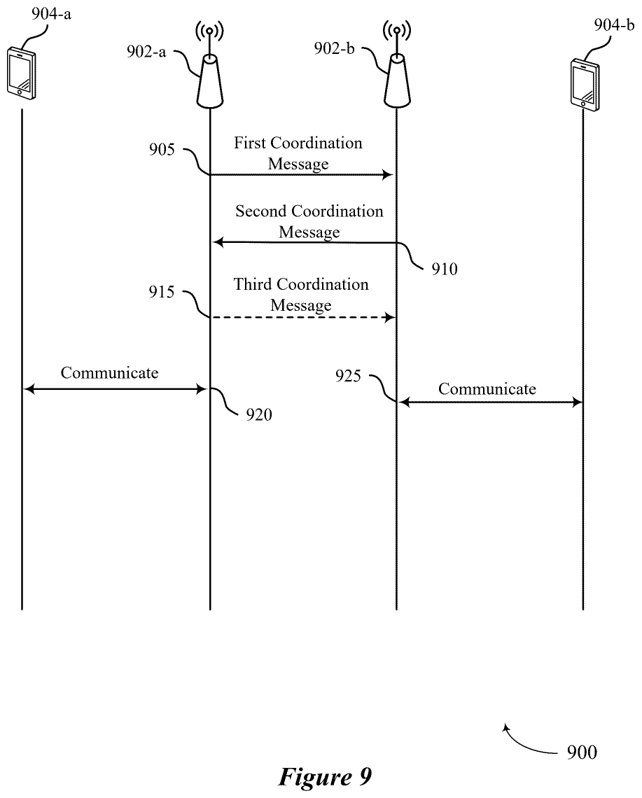

FIG. 9 shows an example of a process flow 900 that supports operations between access points with different channel configurations. The process flow 900 includes an AP 902-a, an AP 902-b, a STA 904-a, and a STA 904-b, which may be examples of the corresponding devices described herein with respect to FIGS. 1 through 8. Alternative examples of the following may be implemented, where some operations are performed in a different order than described or are not performed at all. In some cases, operations may include additional features not mentioned below, or further operations may be added. Although the AP 902-a, the AP 902-b, the STA 904-a, and the STA 904-b are shown performing the operations of the process flow 900, some aspects of some operations may also be performed by one or more other components or systems.

In accordance with one or more first implementations of the process flow 900, the AP 902-a and the AP 902-b may be configured or required to use the same bandwidth for a primary channel (e.g., the same primary channel).

At 905, the first AP 902-a may transmit, to one or more second access points via a primary channel, a first coordination message comprising at least one of first information associated with coordination of resources of a transmission opportunity or second information associated with allocation of resources associated with the coordination. The first coordination message may be an example of a control frame of a coordinated access point procedure (e.g., an ICF of a C-TDMA procedure). The first information may be communicated via the primary channel based at least in part on the first access point and the one or more second access points being configured to use a same primary channel. In some examples, the control frame may trigger a TB-PPDU response from one or more second access points. For example, the control frame may include a BSRP trigger frame. Additionally, or alternatively, the control frame may not solicit a PPDU response, and may be an example of a MU-RTS message or a MU-BAR message. In some cases, the first coordination message may be an example of a frame that allocates resources of the transmission opportunity. Additionally, or alternatively, the first information or the second information of the first coordination message may include a subchannel mapping of each subchannel of multiple subchannels to a respective second access point of the one or more second access points. The multiple subchannels may include resources of a frequency bandwidth of an operating bandwidth used by the first access point that overlap with resources of one or more second operating bandwidths used by the one or more second access points.

At 910, the first AP 902-a may receive, from the second AP 902-b of the one or more second access points, a second coordination message comprising third information associated with the coordination of or the allocation of the resources of the transmission opportunity. The third information, included in the second communication message, may be communicated via the primary channel based at least in part on the first access point and the one or more second access points being configured to use a same primary channel. In some examples, either the first information or the third information may be communicated via the primary channel. In some examples, both the first information and the third information may be communicated via the primary channel. In some examples, the second coordination message is a PPDU response (e.g., a BSRP) that is received via a RU allocated to the second access point by the first information or the second information. Additionally, or alternatively, the second coordination message is received via a subchannel indicated by the first coordination message. In some examples, the third information is indicative of an operating bandwidth of the second access point, a puncturing pattern to be used by the second access point, or both.

At 915, the AP 902-a may transmit to the second AP 902-b in response to receiving the second coordination message, a third coordination message comprising the second information associated with the allocation of resource association with the coordination. In such cases, the first coordination message includes the first information associated with the coordination of the resources. The third coordination message may be transmitted via the primary channel based on the first AP 902-a and the second AP 902-b being configured to use the same primary channel. In some examples, the first coordination message is an ICF, and the third coordination message is a TXOP allocation frame. In such cases, the second coordination message may be an ICR, a PPDU response, etc. Additionally, or alternatively, the first coordination message may include information that allocates resources for the TXOP. In such cases, the third coordination message may not be transmitted. Additionally, in such cases, the second coordination message may be an example of a CTS message, a TXOP return message, etc. In some examples, the first coordination message, the second third coordination message, or both, may be indicative of puncturing pattern associated with the resources and to be used by the first AP 902-a.

At 920, the first AP 902-a may communicate with one or more STAs, including the STA 904-a, during at least a first portion of the transmission opportunity based at least in part on the allocation of the resources. In some examples, the first AP 902-a may communicate with one or more second STAs associated with the first AP 902-a via one or more resources separate from the transmission opportunity and included in an operating bandwidth used by the first access point to occupy the one or more resources. The first AP 902-a may communicate with one or more second STAs associated with the second AP 902-b during the same or a different portion of the transmission opportunity.

At 925, the second AP 902-b may communicate with one or more STAs, including the STA 904-b, during at least a first portion of the transmission opportunity based at least in part on the allocation of resources. The second AP 902-b may communicate with one or more second STAs associated with the first AP 902-a during the same or a different portion of the transmission opportunity. The second AP 902-b may communicate with the one or more STAs in accordance with the puncturing pattern transmitted by the first AP 902-a or irrespective of the puncturing pattern transmitted by the first AP 902-a. The transmission opportunity may be within a TWT-SP configured via a first service period. In some cases, the TWT-SP may be associated with a rTWT-SP that coordinated with the second AP 902-b.

In accordance with one or more second implementations of the process flow 900, the AP 902-a and the AP 902-b may be configured to use different bandwidths for respective primary channel. That is, a rule may permit the use of different primary channel bandwidths by the AP 902-a and the AP 902-b.

At 905, the first AP 902-a may transmit, to one or more second access points, a first coordination message including at least one of first information associated with coordination of resources of a transmission opportunity or second information associated with allocation of resources associated with the coordination. The first coordination message comprises an indication of a first primary channel of the first access point based at least in part on the first access point and a second access point of the one or more second access points being configured to use different primary channels. The first coordination message may include a first frame of a CAP procedure (e.g., an ICF of a C-TDMA procedure). The first frame may include a RU allocation or a subchannel mapping. In some examples, the RU allocation or the subchannel mapping may be indicated relative to the first primary channel of the first AP 902-a. For example, the RU allocation or the subchannel mapping may be within an operating bandwidth of the first AP 902-a, such as within the first primary channel of the first AP 902-a. Additionally, or alternatively, the RU allocation or the subchannel mapping is indicated relative to the second primary channel of the second AP 902-b. The RU allocated to or a subchannel mapped to the second AP 902-b may be within an operating bandwidth of the second access point. For example, the RU allocation or the subchannel mapping may be within an operating bandwidth of the second AP 902-b, such as within the second primary channel of the second AP 902-b. The first frame may be a broadcast frame of a CAP procedure. Additionally, or alternatively, the first frame may indicate the first primary channel and a capability of the first AP 902-a (e.g., a UHR capability). Moreover, the first coordination message may be transmitted as a duplicate PPDU (non-HT Duplicate PPDU format) via each channel of multiple subchannels of the operating bandwidth of the first AP 902-a. In some examples, the frame (e.g., that includes the primary channel indication) may trigger a TB-PPDU response from one or more second access points. For example, the control frame may include a BSRP trigger frame. Additionally, or alternatively, the frame may not solicit a PPDU response, and may be an example of a MU-RTS message or a MU-BAR message

At 910, the first AP 902-a may receive, from the second AP 902-b, a second coordination message comprising third information associated with the coordination of or the allocation of the resources of the transmission opportunity. The second coordination message may include receiving, via a resource assigned by the first frame, a response to the first coordination message. The response may include an indication of a second primary channel used by the second AP 902-b. The second coordination message may include the second information that is indicative of an operating bandwidth of the second access point, a puncturing pattern to be used by the second access point, or both.

At 915, the AP 902-a may transmit to the second AP 902-b in response to receiving the second coordination message, a third coordination message comprising the second information associated with the allocation of resource association with the coordination. In such cases, the first coordination message includes the first information associated with the coordination of the resources. The third coordination message may be transmitted via the primary channel based on the first AP 902-a and the second AP 902-b being configured to use the same primary channel. In some examples, the first coordination message is an ICF, and the third coordination message is a TXOP allocation frame. In such cases, the second coordination message may be an ICR, a PPDU response, etc. Additionally, or alternatively, the first coordination message may include information that allocates resources for the TXOP. In such cases, the third coordination message may not be transmitted. Additionally, in such cases, the second coordination message may be an example of a CTS message, a TXOP return message, etc. In some examples, the first coordination message or the second third coordination message, or both, may be indicative of puncturing pattern associated with the resources and to be used by the first AP 902-a.

At 920, the first AP 902-a may communicate with one or more STAs, including the STA 904-a, during at least a first portion of the transmission opportunity based at least in part on the allocation of the resources. In some examples, the first AP 902-a may communicate with one or more second STAs associated with the first AP 902-a via one or more resources separate from the transmission opportunity and included in an operating bandwidth used by the first access point to occupy the one or more resources. The first AP 902-a may communicate with one or more second STAs associated with the second AP 902-b during the same or a different portion of the transmission opportunity.

At 925, the second AP 902-b may communicate with one or more STAs, including the STA 904-b, during at least a first portion of the transmission opportunity based at least in part on the allocation of resources. The second AP 902-b may communicate with one or more second STAs associated with the first AP 902-a during the same or a different portion of the transmission opportunity. The second AP 902-b may communicate with the one or more STAs in accordance with the puncturing pattern transmitted by the first AP 902-a or irrespective of the puncturing pattern transmitted by the first AP 902-a. The transmission opportunity may be within a TWT-SP configured via a first service period. In some cases, the TWT-SP may be associated with a rTWT-SP that coordinated with the second AP 902-b.

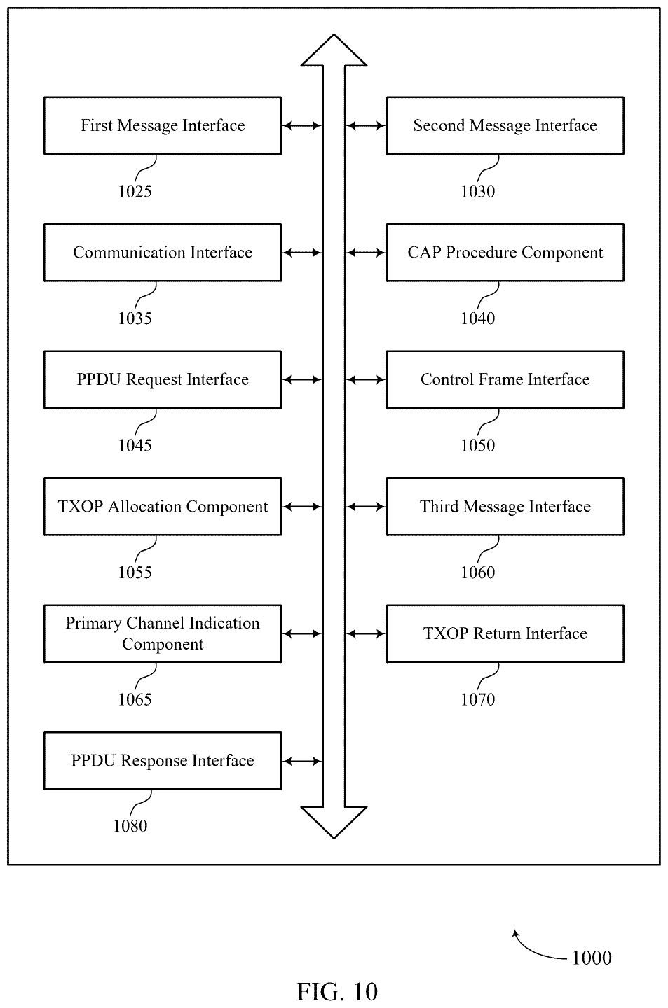

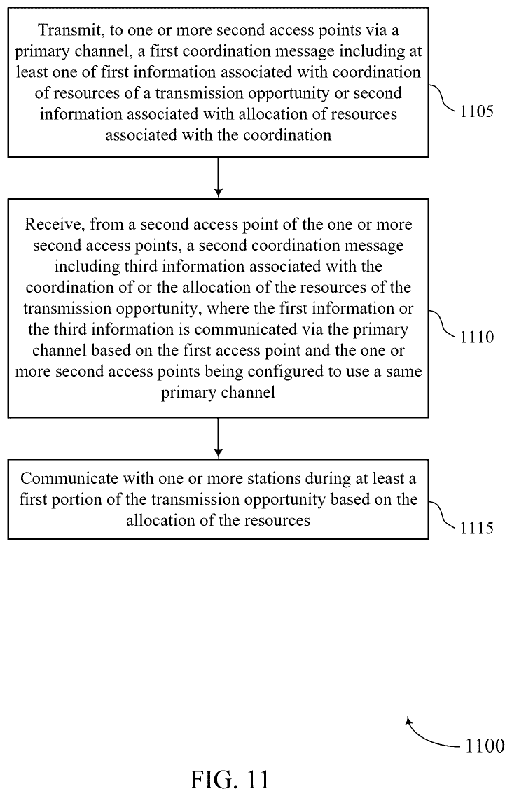

FIG. 10 shows a block diagram of an example wireless communication device 1000 that supports operations between access points with different channel configurations. In some examples, the wireless communication device 1000 is configured to perform the processes 1100, 1200, 1300, and 1400 described with reference to FIGS. 11, 12, 13, and 14, respectively. The wireless communication device 1000 may include one or more chips, SoCs, chipsets, packages, components or devices that individually or collectively constitute or include a processing system. The processing system may interface with other components of the wireless communication device 1000, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1000 may transmit the information output from the chip. In such an example, the second interface may refer to an interface between the processing system of the chip and a reception component, such that the wireless communication device 1000 may receive information that is then passed to the processing system. In some such examples, the first interface also may obtain information, such as from the transmission component, and the second interface also may output information, such as to the reception component.

The processing system of the wireless communication device 1000 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1000 can be configurable or configured for use in an AP, such as the AP 102 described with reference to FIG. 1. In some other examples, the wireless communication device 1000 can be an AP that includes such a processing system and other components including multiple antennas. The wireless communication device 1000 is capable of transmitting and receiving wireless communications in the form of, for example, wireless packets. For example, the wireless communication device 1000 can be configurable or configured to transmit and receive packets in the form of physical layer PPDUs and MPDUs conforming to one or more of the IEEE 802.11 family of wireless communication protocol standards. In some other examples, the wireless communication device 1000 can be configurable or configured to transmit and receive signals and communications conforming to one or more 3GPP specifications including those for 5G NR or 6G. In some examples, the wireless communication device 1000 also includes or can be coupled with one or more application processors which may be further coupled with one or more other memories. In some examples, the wireless communication device 1000 further includes at least one external network interface coupled with the processing system that enables communication with a core network or backhaul network that enables the wireless communication device 1000 to gain access to external networks including the Internet.

The wireless communication device 1000 includes a first message interface 1025, a second message interface 1030, a communication interface 1035, a CAP procedure component 1040, a PPDU request interface 1045, a control frame interface 1050, a TXOP allocation component 1055, a third message interface 1060, a primary channel indication component 1065, a TXOP return interface 1070, and a PPDU response interface 1080. Portions of one or more of the first message interface 1025, the second message interface 1030, the communication interface 1035, the CAP procedure component 1040, the PPDU request interface 1045, the control frame interface 1050, the TXOP allocation component 1055, the third message interface 1060, the primary channel indication component 1065, the TXOP return interface 1070, and the PPDU response interface 1080 may be implemented at least in part in hardware or firmware. For example, one or more of the first message interface 1025, the second message interface 1030, the communication interface 1035, the CAP procedure component 1040, the PPDU request interface 1045, the control frame interface 1050, the TXOP allocation component 1055, the third message interface 1060, the primary channel indication component 1065, the TXOP return interface 1070, and the PPDU response interface 1080 may be implemented at least in part by at least a processor or a modem. In some examples, portions of one or more of the first message interface 1025, the second message interface 1030, the communication interface 1035, the CAP procedure component 1040, the PPDU request interface 1045, the control frame interface 1050, the TXOP allocation component 1055, the third message interface 1060, the primary channel indication component 1065, the TXOP return interface 1070, and the PPDU response interface 1080 may be implemented at least in part by a processor and software in the form of processor-executable code stored in memory.

The wireless communication device 1000 may support wireless communications in accordance with examples as disclosed herein. The first message interface 1025 is configurable or configured to transmit, to one or more second access points via a primary channel, a first coordination message including at least one of first information associated with coordination of resources of a transmission opportunity or second information associated with allocation of resources associated with the coordination. The second message interface 1030 is configurable or configured to receive, from a second access point of the one or more second access points, a second coordination message including third information associated with the coordination of or the allocation of the resources of the transmission opportunity, where the first information or the third information is communicated via the primary channel based on the first access point and the one or more second access points being configured to use a same primary channel. The communication interface 1035 is configurable or configured to communicate with one or more stations during at least a first portion of the transmission opportunity based on the allocation of the resources.

In some examples, to support transmitting the first coordination message, the CAP procedure component 1040 is configurable or configured to transmit, via the primary channel, a control frame of a coordinated access point procedure, where the control frame includes the first information.

In some examples, the control frame is an initial control frame of a C-TDMA procedure.

In some examples, to support transmitting the first coordination message, the PPDU request interface 1045 is configurable or configured to transmit, via the primary channel, a control frame including the first information that triggers a physical protocol data unit response by the second access point.

In some examples, to support receiving the second coordination message, the PPDU response interface 1080 is configurable or configured to receive the physical protocol data unit response via a resource unit allocated to the second access point by the first information or the second information.

In some examples, the control frame includes a buffer status report trigger frame, and the physical protocol data unit response includes a buffer status report of the second access point.

In some examples, to support transmitting the first coordination message, the control frame interface 1050 is configurable or configured to transmit, via the primary channel, a control frame including the first information or the second information that does not solicit a physical protocol data unit response from at least one of the one or more second access points.

In some examples, the control frame includes a multi-user request to send (MU-RTS) frame or a multi-user block acknowledgement request (MU-BAR).

In some examples, to support transmitting the first coordination message, the TXOP allocation component 1055 is configurable or configured to transmit, via the primary channel, a frame that allocates the resources of the transmission opportunity.

In some examples, the first coordination message transmitted via the primary channel includes a multi-user request to send (MU-RTS) message or a buffer status report trigger frame.

In some examples, the first information or the second information includes a subchannel mapping of each subchannel of a set of multiple subchannels to a respective second access point of the one or more second access points.

In some examples, the set of multiple subchannels includes resources of a radio frequency bandwidth of an operating bandwidth used by the first access point that overlap with resources of one or more second operating bandwidths used by the one or more second access points.

In some examples, the communication interface 1035 is configurable or configured to communicate with one or more second stations associated with the first access point via one or more resources separate from the transmission opportunity and included in an operating bandwidth used by the first access point to occupy the one or more resources.

In some examples, the third information is indicative of an operating bandwidth of the second access point, a puncturing pattern to be used by the second access point, or both.

In some examples, to support communicating with the one or more stations, the communication interface 1035 is configurable or configured to communicate with the one or more stations that are associated with the first access point during the at least the first portion of the transmission opportunity. In some examples, to support communicating with the one or more stations, the communication interface 1035 is configurable or configured to communicate with one or more second stations associated with the second access point during at least a second portion of the transmission opportunity.

In some examples, the at least the first portion of the transmission opportunity and the at least the second portion of the transmission opportunity are a same portion or different portions of the transmission opportunity.

In some examples, the transmission opportunity is within a target wait time service period (TWT-SP) configured via a first service period.

In some examples, the TWT-SP is associated with a restricted TWT (rTWT) service period that is coordinated with the second access point.

In some examples, the third message interface 1060 is configurable or configured to transmit, to the second access point in response to receiving the second coordination message, a third coordination message including the second information associated with the allocation of resource association with the coordination, where the first coordination message includes the first information associated with the coordination of the resources.

Additionally, or alternatively, the wireless communication device 1000 may support wireless communications in accordance with examples as disclosed herein. In some examples, the first message interface 1025 is configurable or configured to receive, from a second access point via a primary channel of the first access point, a first coordination message including at least one of first information associated with coordination of resources of a transmission opportunity or second information associated with allocation of resources associated with the coordination. In some examples, the second message interface 1030 is configurable or configured to transmit, to the second access point, a second coordination message including third information associated with the coordination of or the allocation of the resources of the transmission opportunity, where the first information or the third information is communicated via the primary channel based on the first access point and the second access point being configured to use a same primary channel. In some examples, the communication interface 1035 is configurable or configured to communicate with one or more stations during at least a first portion of the transmission opportunity based on the allocation of the resources.

In some examples, to support receiving the first coordination message, the CAP procedure component 1040 is configurable or configured to receive, via the primary channel, a control frame of a coordinated access point procedure, where the control frame includes the first information.

In some examples, the control frame includes an initial control frame of a C-TDMA procedure.

In some examples, to support receiving the first coordination message, the PPDU request interface 1045 is configurable or configured to receive, via the primary channel, a control frame including the first information that triggers a physical protocol data unit response by the second access point.

In some examples, to support transmitting the second coordination message, the PPDU response interface 1080 is configurable or configured to transmit the physical protocol data unit response via a resource unit allocated to the second access point by the first information.

In some examples, the control frame includes a buffer status report trigger frame, and the physical protocol data unit response includes a buffer status report of the first access point.

In some examples, to support receiving the first coordination message, the control frame interface 1050 is configurable or configured to receive, via the primary channel, a control frame including the first information that does not solicit a physical protocol data unit response from the first access point.

In some examples, the control frame includes a multi-user request to send (MU-RTS) frame or a multi-user block acknowledgement request (MU-BAR).

In some examples, to support receiving the first coordination message, the TXOP allocation component 1055 is configurable or configured to receive, via the primary channel, a frame that allocates the resources of the transmission opportunity. In some examples, the resources allocated by the frame may be within the primary channel.

In some examples, the first coordination message received via the primary channel is a multi-user request to send (MU-RTS) message.

In some examples, the first information or the second information includes a subchannel mapping of a subchannel of a set of multiple subchannels to the first access point.

In some examples, the subchannel allocated to the first access point is within an operating bandwidth used by the first access point.

In some examples, the second information is indicative of an operating bandwidth of the first access point, a puncturing pattern to be used by the first access point, or both.

In some examples, the third information is indicative of an operating bandwidth of the second access point, a puncturing pattern to be used by the second access point, or both.

In some examples, to support communicating with the one or more stations, the communication interface 1035 is configurable or configured to communicate with the one or more stations that are associated with the first access point during the at least the first portion of the transmission opportunity. In some examples, to support communicating with the one or more stations, the communication interface 1035 is configurable or configured to communicate with one or more second stations associated with the second access point during at least a second portion of the transmission opportunity.

In some examples, the at least the first portion of the transmission opportunity and the at least the second portion of the transmission opportunity are a same portion or different portions of the transmission opportunity.

In some examples, the transmission opportunity is within a target wait time service period (TWT-SP) configured via a first service period.

In some examples, the TWT-SP is associated with a restricted TWT (rTWT) service period that is coordinated with the second access point.

In some examples, the third message interface 1060 is configurable or configured to receive, from the second access point in response to the second coordination message, a third coordination message including the second information associated with the allocation of resource association with the coordination, where the first coordination message includes the first information associated with the coordination of the resources.

Additionally, or alternatively, the wireless communication device 1000 may support wireless communications in accordance with examples as disclosed herein. In some examples, the first message interface 1025 is configurable or configured to transmit, to one or more second access points, a first coordination message including at least one of first information associated with coordination of resources of a transmission opportunity or second information associated with allocation of resources associated with the coordination, where the first coordination message includes an indication of a first primary channel of the first access point based on the first access point and a second access point of the one or more second access points being configured to use different primary channels. In some examples, the second message interface 1030 is configurable or configured to receive, from the second access point of the one or more second access points, a second coordination message including third information associated with the coordination of or the allocation of the resources of the transmission opportunity. In some examples, the communication interface 1035 is configurable or configured to communicate with one or more stations during at least a first portion of the transmission opportunity based on the allocation of the resources.

In some examples, to support transmitting the first coordination message, the primary channel indication component 1065 is configurable or configured to transmit a first frame of a coordinated access point procedure, where the first frame includes the indication of the first primary channel of the first access point.

In some examples, the first frame includes an initial control frame of a C-TDMA procedure.

In some examples, the first frame includes a resource unit allocation or a subchannel mapping of a set of multiple subchannels to each second access point of the one or more second access points.

In some examples, the resource unit allocation or the subchannel mapping is indicated relative the first primary channel of the first access point.

In some examples, the resource unit allocation or the subchannel mapping is indicated relative to a second primary channel of the second access point.

In some examples, a resource unit allocated to or a subchannel mapped to the second access point is within an operating bandwidth of the second access point.

In some examples, to support receiving the second coordination message, the second message interface 1030 is configurable or configured to receive, via a resource assigned by the first frame, a response to the first coordination message.

In some examples, the response includes an indication of a second primary channel used by the second access point.

In some examples, the first frame is indicative of a second primary channel used by the second access point.

In some examples, the first frame includes a broadcast frame of the coordinated access point procedure.

In some examples, the first frame indicates the first primary channel and a capability of the first access point.

In some examples, to support transmitting the first coordination message, the first message interface 1025 is configurable or configured to transmit each first coordination message of a set of multiple first coordination messages via a different subchannel of a set of multiple subchannels of an operating bandwidth of the first access point.

In some examples, each first coordination message of the set of multiple first coordination messages includes a duplicate physical protocol data unit.

In some examples, the TXOP return interface 1070 is configurable or configured to receive, from the second access point via the first primary channel, a frame that releases at least a portion of the resources of the transmission opportunity.

In some examples, the first coordination message is indicative of a puncturing pattern associated with the resources. In some examples, the first access point communicates with the one or more stations during the transmission opportunity based on the puncturing pattern.

In some examples, the second information is indicative of an operating bandwidth of the second access point, a puncturing pattern to be used by the second access point, or both.

In some examples, to support transmitting the first coordination message, the control frame interface 1050 is configurable or configured to transmit a control frame including the first information or the second information that does not solicit a physical protocol data unit response from at least one second access point of the one or more second access points.

In some examples, the control frame includes a multi-user request to send (MU-RTS) frame or a multi-user block acknowledgement request (MU-BAR).

In some examples, the communication interface 1035 is configurable or configured to communicate with the one or more stations associated with the first access point via one or more resources separate from the transmission opportunity and included in an operating bandwidth used by the first access point to occupy the one or more resources.

In some examples, the third information is indicative of an operating bandwidth of the second access point, a puncturing pattern to be used by the second access point, or both.

In some examples, to support communicating with the one or more stations, the communication interface 1035 is configurable or configured to communicate with the one or more stations that are associated with the first access point during the at least the first portion of the transmission opportunity. In some examples, to support communicating with the one or more stations, the communication interface 1035 is configurable or configured to communicate with one or more second stations associated with the second access point during at least a second portion of the transmission opportunity.

In some examples, the at least the first portion of the transmission opportunity and the at least the second portion of the transmission opportunity are a same portion or different portions of the transmission opportunity.

In some examples, the transmission opportunity is within a target wait time service period (TWT-SP) configured via a first service period.

In some examples, the TWT-SP is associated with a restricted TWT (rTWT) service period that is coordinated with the second access point.

In some examples, the third message interface 1060 is configurable or configured to transmit, to the second access point, in response to receiving the second coordination message, a third coordination message including the second information associated with the allocation of resource association with the coordination, where the first coordination message includes the first information associated with the coordination of the resources.

Additionally, or alternatively, the wireless communication device 1000 may support wireless communications in accordance with examples as disclosed herein. In some examples, the first message interface 1025 is configurable or configured to receive, from a second access point, a first coordination message including at least one of first information associated with coordination of resources of a transmission opportunity or second information associated with allocation of resources associated with the coordination, where the first coordination message includes an indication of a first primary channel of the first access point based on the first access point and the second access point being configured to use different primary channels. In some examples, the second message interface 1030 is configurable or configured to transmit, to the second access point, a second coordination message including third information associated with the coordination of or the allocation of the resources of the transmission opportunity. In some examples, the communication interface 1035 is configurable or configured to communicate with one or more stations during at least a first portion of the transmission opportunity based on the allocation of the resources.

In some examples, to support receiving the first coordination message, the primary channel indication component 1065 is configurable or configured to receive a first frame of a coordinated access point procedure, where the first frame includes the indication of the first primary channel of the second access point.

In some examples, the first frame includes an initial control frame of a C-TDMA procedure.

In some examples, the first frame includes an allocation of a resource unit to the first access point or a subchannel mapping of a subchannel to the first access point.

In some examples, the resource unit or the subchannel is indicated relative the first primary channel of the first access point.

In some examples, the resource unit or the subchannel is indicated relative to a second primary channel of the second access point.

In some examples, a resource unit or the subchannel is within an operating bandwidth of the first access point.

In some examples, to support transmitting the second coordination message, the second message interface 1030 is configurable or configured to transmit, via a resource assigned by the first coordination message, a response to the first coordination message.

In some examples, the response includes an indication of a second primary channel used by the first access point.

In some examples, the first frame is indicative of a second primary channel used by the first access point.

In some examples, the first frame includes a broadcast frame of the coordinated access point procedure.

In some examples, the first frame indicates the first primary channel and a capability of the second access point.

In some examples, to support receiving the first coordination message, the first message interface 1025 is configurable or configured to receive, via a second primary channel of the first access point, a duplicate physical protocol data unit including the indication of the first primary channel.

In some examples, the TXOP return interface 1070 is configurable or configured to transmit, to the second access point via the first primary channel, a frame that releases at least a portion of the resources of the transmission opportunity.

In some examples, the first coordination message is indicative of a puncturing pattern associated with the resources. In some examples, the first access point communicates with the one or more stations during the transmission opportunity based on the puncturing pattern.

In some examples, the first coordination message, is indicative of a puncturing pattern associated with the resources. In some examples, the first access point communicates with the one or more stations during the transmission opportunity irrespective of the puncturing pattern.

In some examples, to support communicating with the one or more stations, the communication interface 1035 is configurable or configured to communicate with the one or more stations during at least the portion of the transmission opportunity using a puncturing pattern assigned by the first access point.

In some examples, the second information is indicative of an operating bandwidth of the first access point, a puncturing pattern to be used by the first access point, or both.

In some examples, to support receiving the first coordination message, the control frame interface 1050 is configurable or configured to receive a control frame including the first information or the second information that does not solicit a physical protocol data unit response from the second access point.

In some examples, the control frame includes a multi-user request to send (MU-RTS) frame or a multi-user block acknowledgement request (MU-BAR).

In some examples, the third information is indicative of an operating bandwidth of the second access point, a puncturing pattern to be used by the second access point, or both.

In some examples, to support communicating with the one or more stations, the communication interface 1035 is configurable or configured to communicate with the one or more stations that are associated with the first access point during the at least the first portion of the transmission opportunity. In some examples, to support communicating with the one or more stations, the communication interface 1035 is configurable or configured to communicate with one or more second stations associated with the second access point during at least a second portion of the transmission opportunity.

In some examples, the at least the first portion of the transmission opportunity and the at least the second portion of the transmission opportunity are a same portion or different portions of the transmission opportunity.

In some examples, the transmission opportunity is within a target wait time service period (TWT-SP) configured via a first service period.

In some examples, the TWT-SP is associated with a restricted TWT (rTWT) service period that is coordinated with the second access point.

In some examples, the third message interface 1060 is configurable or configured to receive, from the second access point in response to the second coordination message, a third coordination message including the second information associated with the allocation of resource association with the coordination, where the first coordination message includes the first information associated with the coordination of the resources.

FIG. 11 shows a flowchart illustrating an example process 1100 performable by or at a first access point that supports operations between access points with different channel configurations. The operations of the process 1100 may be implemented by a first access point or its components as described herein. For example, the process 1100 may be performed by a wireless communication device, such as the wireless communication device 1000 described with reference to FIG. 10, operating as or within a wireless AP. In some examples, the process 1100 may be performed by a wireless AP, such as one of the APs 102 described with reference to FIG. 1.

In some examples, in 1105, the first access point may transmit, to one or more second access points via a primary channel, a first coordination message including at least one of first information associated with coordination of resources of a transmission opportunity or second information associated with allocation of resources associated with the coordination. The operations of 1105 may be performed in accordance with examples as disclosed herein, such as transmission of the first coordination message at 905 of FIG. 9, transmission of the ICF at 705 of FIG. 7, transmission of the TXOP allocation (MU-RTS TxX) at 720 of FIG. 7. In some implementations, aspects of the operations of 1105 may be performed by a first message interface 1025 as described with reference to FIG. 10.

In some examples, in 1110, the first access point may receive, from a second access point of the one or more second access points, a second coordination message including third information associated with the coordination of or the allocation of the resources of the transmission opportunity, where the first information or the third information is communicated via the primary channel based on the first access point and the one or more second access points being configured to use a same primary channel. The operations of 1110 may be performed in accordance with examples as disclosed herein, such as transmission of the second coordination message at 910 of FIG. 9, transmission of the ICR at 710 of FIG. 7, transmission of the CTS at 725 of FIG. 7, or transmission of the TXOP return at 735 of FIG. 7. In some implementations, aspects of the operations of 1110 may be performed by a second message interface 1030 as described with reference to FIG. 10.

In some examples, in 1115, the first access point may communicate with one or more stations during at least a first portion of the transmission opportunity based on the allocation of the resources. The operations of 1115 may be performed in accordance with examples as disclosed herein, such as communication with STAs as shown at 715 of FIG. 7 and communication at 920 of FIG. 9. In some implementations, aspects of the operations of 1115 may be performed by a communication interface 1035 as described with reference to FIG. 10.

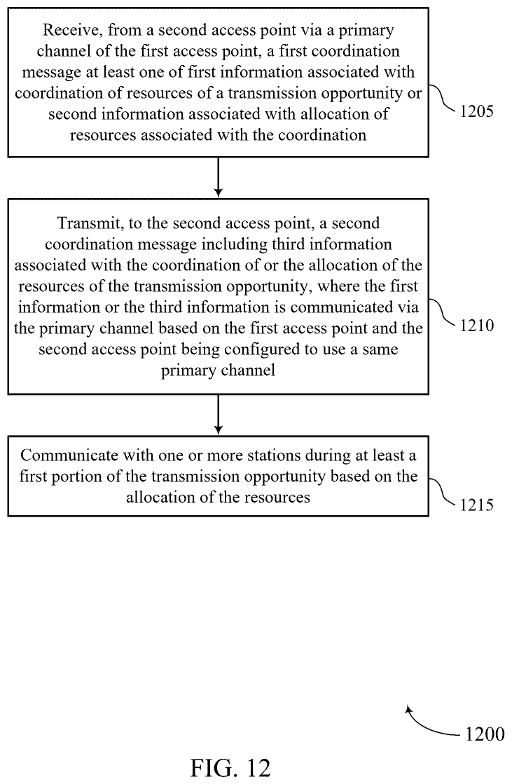

FIG. 12 shows a flowchart illustrating an example process 1200 performable by or at a first access point that supports operations between access points with different channel configurations. The operations of the process 1200 may be implemented by a first access point or its components as described herein. For example, the process 1200 may be performed by a wireless communication device, such as the wireless communication device 1000 described with reference to FIG. 10, operating as or within a wireless AP. In some examples, the process 1200 may be performed by a wireless AP, such as one of the APs 102 described with reference to FIG. 1.

In some examples, in 1205, the first access point may receive, from a second access point via a primary channel of the first access point, a first coordination message including at least one of first information associated with coordination of resources of a transmission opportunity or second information associated with allocation of resources associated with the coordination. The operations of 1205 may be performed in accordance with examples as disclosed herein, such as transmission of the first coordination message at 905 of FIG. 9, transmission of the ICF at 705 of FIG. 7, or transmission of the TXOP allocation (MU-RTS TxX) at 720 of FIG. 7. In some implementations, aspects of the operations of 1205 may be performed by a first message interface 1025 as described with reference to FIG. 10.

In some examples, in 1210, the first access point may transmit, to the second access point, a second coordination message including third information associated with the coordination of or the allocation of the resources of the transmission opportunity, where the first information or the third information is communicated via the primary channel based on the first access point and the second access point being configured to use a same primary channel. The operations of 1210 may be performed in accordance with examples as disclosed herein, such as transmission of the second coordination message at 910 of FIG. 9, transmission of the ICR at 710 of FIG. 7, transmission of the CTS at 725 of FIG. 7, or transmission of the TXOP return at 735 of FIG. 7. In some implementations, aspects of the operations of 1210 may be performed by a second message interface 1030 as described with reference to FIG. 10.

In some examples, in 1215, the first access point may communicate with one or more stations during at least a first portion of the transmission opportunity based on the allocation of the resources. The operations of 1215 may be performed in accordance with examples as disclosed herein, such as communication with STAs as shown at 730 of FIG. 7 and communication at 925 of FIG. 9. In some implementations, aspects of the operations of 1215 may be performed by a communication interface 1035 as described with reference to FIG. 10.

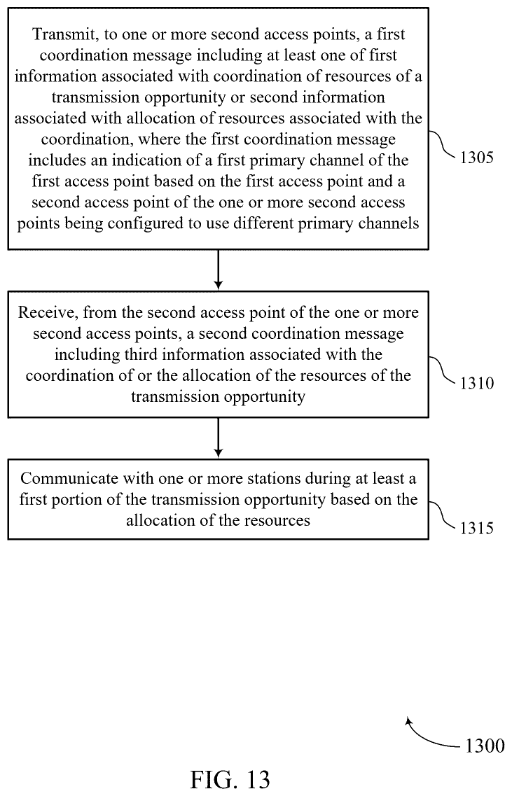

FIG. 13 shows a flowchart illustrating an example process 1300 performable by or at a first access point that supports operations between access points with different channel configurations. The operations of the process 1300 may be implemented by a first access point or its components as described herein. For example, the process 1300 may be performed by a wireless communication device, such as the wireless communication device 1000 described with reference to FIG. 10, operating as or within a wireless AP. In some examples, the process 1300 may be performed by a wireless AP, such as one of the APs 102 described with reference to FIG. 1.

In some examples, in 1305, the first access point may transmit, to one or more second access points, a first coordination message including at least one of first information associated with coordination of resources of a transmission opportunity or second information associated with allocation of resources associated with the coordination, where the first coordination message includes an indication of a first primary channel of the first access point based on the first access point and a second access point of the one or more second access points being configured to use different primary channels. The operations of 1305 may be performed in accordance with examples as disclosed herein, such as transmission of the first coordination message at 905 of FIG. 9, transmission of the ICF at 705 of FIG. 7, transmission of the TXOP allocation (MU-RTS TxX) at 720 of FIG. 7. In some implementations, aspects of the operations of 1305 may be performed by a first message interface 1025 as described with reference to FIG. 10.

In some examples, in 1310, the first access point may receive, from the second access point of the one or more second access points, a second coordination message including third information associated with the coordination of or the allocation of the resources of the transmission opportunity. The operations of 1310 may be performed in accordance with examples as disclosed herein, such as transmission of the second coordination message at 910 of FIG. 9, transmission of the ICR at 710 of FIG. 7, transmission of the CTS at 725 of FIG. 7, or transmission of the TXOP return at 735 of FIG. 7. In some implementations, aspects of the operations of 1310 may be performed by a second message interface 1030 as described with reference to FIG. 10.

In some examples, in 1315, the first access point may communicate with one or more stations during at least a first portion of the transmission opportunity based on the allocation of the resources. The operations of 1315 may be performed in accordance with examples as disclosed herein, such as communication with STAs as shown at 715 of FIG. 7 and communication at 920 of FIG. 9. In some implementations, aspects of the operations of 1315 may be performed by a communication interface 1035 as described with reference to FIG. 10.

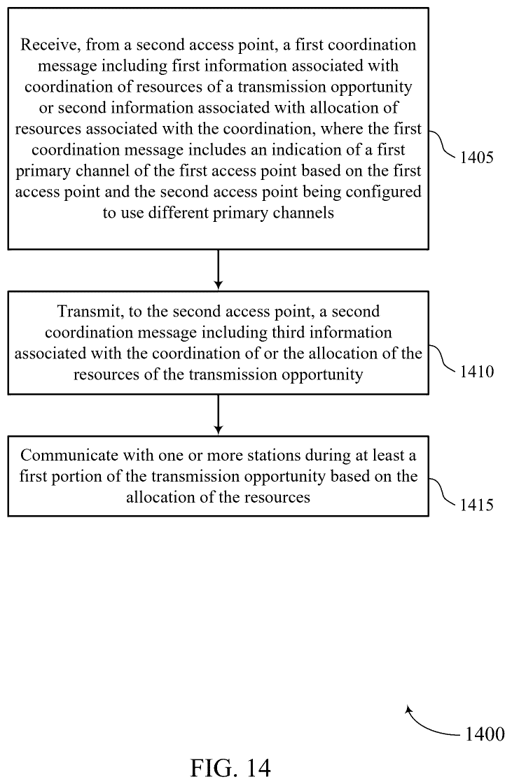

FIG. 14 shows a flowchart illustrating an example process 1400 performable by or at a first access point that supports operations between access points with different channel configurations. The operations of the process 1400 may be implemented by a first access point or its components as described herein. For example, the process 1400 may be performed by a wireless communication device, such as the wireless communication device 1000 described with reference to FIG. 10, operating as or within a wireless AP. In some examples, the process 1400 may be performed by a wireless AP, such as one of the APs 102 described with reference to FIG. 1.

In some examples, in 1405, the first access point may receive, from a second access point, a first coordination message including at least one of first information associated with coordination of resources of a transmission opportunity or second information associated with allocation of resources associated with the coordination, where the first coordination message includes an indication of a first primary channel of the first access point based on the first access point and the second access point being configured to use different primary channels. The operations of 1405 may be performed in accordance with examples as disclosed herein, such as transmission of the first coordination message at 905 of FIG. 9, transmission of the ICF at 705 of FIG. 7, or transmission of the TXOP allocation (MU-RTS TxX) at 720 of FIG. 7. In some implementations, aspects of the operations of 1405 may be performed by a first message interface 1025 as described with reference to FIG. 10.

In some examples, in 1410, the first access point may transmit, to the second access point, a second coordination message including third information associated with the coordination of or the allocation of the resources of the transmission opportunity; and. The operations of 1410 may be performed in accordance with examples as disclosed herein, such as transmission of the second coordination message at 910 of FIG. 9, transmission of the ICR at 710 of FIG. 7, transmission of the CTS at 725 of FIG. 7, or transmission of the TXOP return at 735 of FIG. 7. In some implementations, aspects of the operations of 1410 may be performed by a second message interface 1030 as described with reference to FIG. 10.

In some examples, in 1415, the first access point may communicate with one or more stations during at least a first portion of the transmission opportunity based on the allocation of the resources. The operations of 1415 may be performed in accordance with examples as disclosed herein, such as communication with STAs as shown at 730 of FIG. 7 and communication at 925 of FIG. 9. In some implementations, aspects of the operations of 1415 may be performed by a communication interface 1035 as described with reference to FIG. 10.

The following provides an overview of aspects of the present disclosure:
Aspect 1: A method for wireless communications at a first access point, comprising: transmitting, to one or more second access points via a primary channel, a first coordination message comprising at least one of first information associated with coordination of resources of a transmission opportunity or second information associated with allocation of resources associated with the coordination; receiving, from a second access point of the one or more second access points, a second coordination message comprising third information associated with the coordination of or the allocation of the resources of the transmission opportunity, where the first information or the third information is communicated via the primary channel based at least in part on the first access point and the one or more second access points being configured to use a same primary channel; and communicating with one or more stations during at least a first portion of the transmission opportunity based at least in part on the allocation of the resources.
Aspect 2: The method of aspect 1, where transmitting the first coordination message includes: transmitting, via the primary channel, a control frame of a coordinated access point procedure, where the control frame includes the first information.
Aspect 3: The method of aspect 2, where the control frame is an initial control frame of a C-TDMA procedure.
Aspect 4: The method of any of aspects 1-3, where transmitting the first coordination message includes: transmitting, via the primary channel, a control frame comprising the first information that triggers a physical protocol data unit response by the second access point.
Aspect 5: The method of aspect 4, where receiving the second coordination message includes: receiving the physical protocol data unit response via a resource unit allocated to the second access point by the first information or the second information.
Aspect 6: The method of any of aspects 4-5, where the control frame includes a buffer status report trigger frame, and the physical protocol data unit response includes a buffer status report of the second access point.
Aspect 7: The method of any of aspects 1-3, where transmitting the first coordination message includes: transmitting, via the primary channel, a control frame comprising the first information or the second information that does not solicit a physical protocol data unit response from at least one of the one or more second access points.
Aspect 8: The method of aspect 7, where the control frame includes a multi-user request to send (MU-RTS) frame or a multi-user block acknowledgement request (MU-BAR).
Aspect 9: The method of any of aspects 1-8, where transmitting the first coordination message includes: transmitting, via the primary channel, a frame that allocates the resources of the transmission opportunity.
Aspect 10: The method of aspect 9, where the first coordination message transmitted via the primary channel includes a multi-user request to send (MU-RTS) message or a buffer status report trigger frame.
Aspect 11: The method of any of aspects 9-10, where the first information or the second information includes a subchannel mapping of each subchannel of a plurality of subchannels to a respective second access point of the one or more second access points.
Aspect 12: The method of aspect 11, where the plurality of subchannels includes resources of a radio frequency bandwidth of an operating bandwidth used by the first access point that overlap with resources of one or more second operating bandwidths used by the one or more second access points.
Aspect 13: The method of any of aspects 9-12, further comprising: communicating with one or more second stations associated with the first access point via one or more resources separate from the transmission opportunity and included in an operating bandwidth used by the first access point to occupy the one or more resources.
Aspect 14: The method of any of aspects 1-13, where the third information is indicative of an operating bandwidth of the second access point, a puncturing pattern to be used by the second access point, or both.
Aspect 15: The method of any of aspects 1-14, where communicating with the one or more stations includes: communicating with the one or more stations that are associated with the first access point during the at least the first portion of the transmission opportunity; and communicating with one or more second stations associated with the second access point during at least a second portion of the transmission opportunity.
Aspect 16: The method of aspect 15, where the at least the first portion of the transmission opportunity and the at least the second portion of the transmission opportunity are a same portion of the transmission opportunity, different portions of the transmission opportunity, or at least partially overlapping portions of the transmission opportunity.
Aspect 17: The method of any of aspects 1-16, where the transmission opportunity is within a target wait time service period (TWT-SP) configured via a first service period.
Aspect 18: The method of aspect 17, where the TWT-SP is associated with a restricted TWT (rTWT) service period that is coordinated with the second access point.
Aspect 19: The method of any of aspects 1-18, further comprising: transmitting, to the second access point in response to receiving the second coordination message, a third coordination message comprising the second information associated with the allocation of resource association with the coordination, where the first coordination message includes the first information associated with the coordination of the resources.
Aspect 20: The method of any of aspects 1-19, where the second coordination message includes a buffer status report, a clear to send message, a multi-station blockack message, a message carrying buffer status information, a message carrying resource request information, a public management frame, or any combination thereof.
Aspect 21: A method for wireless communications at a first access point, comprising: receiving, from a second access point via a primary channel of the first access point, a first coordination message comprising at least one of first information associated with coordination of resources of a transmission opportunity or second information associated with allocation of resources associated with the coordination; transmitting, to the second access point, a second coordination message comprising third information associated with the coordination of or the allocation of the resources of the transmission opportunity, where the first information or the third information is communicated via the primary channel based at least in part on the first access point and the second access point being configured to use a same primary channel; and communicating with one or more stations during at least a first portion of the transmission opportunity based at least in part on the allocation of the resources.
Aspect 22: The method of aspect 21, where receiving the first coordination message includes: receiving, via the primary channel, a control frame of a coordinated access point procedure, where the control frame includes the first information.
Aspect 23: The method of aspect 22, where the control frame includes an initial control frame of a C-TDMA procedure.
Aspect 24: The method of any of aspects 21-23, where receiving the first coordination message includes: receiving, via the primary channel, a control frame comprising the first information that triggers a physical protocol data unit response by the second access point.
Aspect 25: The method of aspect 24, where transmitting the second coordination message includes: transmitting the physical protocol data unit response via a resource unit allocated to the second access point by the first information.
Aspect 26: The method of any of aspects 24-25, where the control frame includes a buffer status report trigger frame, and the physical protocol data unit response includes a buffer status report of the first access point.
Aspect 27: The method of any of aspects 21-26, where receiving the first coordination message includes: receiving, via the primary channel, a control frame comprising the first information that does not solicit a physical protocol data unit response from the first access point.
Aspect 28: The method of aspect 27, where the control frame includes a multi-user request to send (MU-RTS) frame or a multi-user block acknowledgement request (MU-BAR).
Aspect 29: The method of any of aspects 21-28, where receiving the first coordination message includes: receiving, via the primary channel, a frame that allocates the resources of the transmission opportunity.
Aspect 30: The method of aspect 29, where the first coordination message received via the primary channel is a multi-user request to send (MU-RTS) message.
Aspect 31: The method of any of aspects 29-30, where the first information or the second information includes a subchannel mapping of a subchannel of a plurality of subchannels to the first access point.
Aspect 32: The method of aspect 31, where the subchannel allocated to the first access point is within an operating bandwidth used by the first access point.
Aspect 33: The method of any of aspects 21-32, where the second information is indicative of an operating bandwidth of the first access point, a puncturing pattern to be used by the first access point, or both.
Aspect 34: The method of any of aspects 21-33, where the third information is indicative of an operating bandwidth of the second access point, a puncturing pattern to be used by the second access point, or both.
Aspect 35: The method of any of aspects 21-34, where communicating with the one or more stations includes: communicating with the one or more stations that are associated with the first access point during the at least the first portion of the transmission opportunity; and communicating with one or more second stations associated with the second access point during at least a second portion of the transmission opportunity.
Aspect 36: The method of aspect 35, where the at least the first portion of the transmission opportunity and the at least the second portion of the transmission opportunity are a same portion of the transmission opportunity, different portions of the transmission opportunity, or at least partially overlapping portions of the transmission opportunity.
Aspect 37: The method of any of aspects 21-36, where the transmission opportunity is within a target wait time service period (TWT-SP) configured via a first service period.
Aspect 38: The method of aspect 37, where the TWT-SP is associated with a restricted TWT (rTWT) service period that is coordinated with the second access point.
Aspect 39: The method of any of aspects 21-38, further comprising: receiving, from the second access point in response to the second coordination message, a third coordination message comprising the second information associated with the allocation of resource association with the coordination, where the first coordination message includes the first information associated with the coordination of the resources.
Aspect 40: The method of any of aspects 21-39, where the second coordination message includes a buffer status report, a clear to send message, a multi-station blockack message, a message carrying buffer status information, a message carrying resource request information, a public management frame, or any combination thereof.
Aspect 41: A method for wireless communications at a first access point, comprising: transmitting, to one or more second access points, a first coordination message comprising at least one of first information associated with coordination of resources of a transmission opportunity or second information associated with allocation of resources associated with the coordination, where the first coordination message includes an indication of a first primary channel of the first access point based at least in part on the first access point and a second access point of the one or more second access points being configured to use different primary channels; receiving, from the second access point of the one or more second access points, a second coordination message comprising third information associated with the coordination of or the allocation of the resources of the transmission opportunity; and communicating with one or more stations during at least a first portion of the transmission opportunity based at least in part on the allocation of the resources.
Aspect 42: The method of aspect 41, where transmitting the first coordination message includes: transmitting a first frame of a coordinated access point procedure, where the first frame includes the indication of the first primary channel of the first access point.
Aspect 43: The method of aspect 42, where the first frame includes an initial control frame of a C-TDMA procedure.
Aspect 44: The method of any of aspects 42-43, where the first frame includes a resource unit allocation or a subchannel mapping of a plurality of subchannels to each second access point of the one or more second access points.
Aspect 45: The method of aspect 44, where the resource unit allocation or the subchannel mapping is indicated relative the first primary channel of the first access point.
Aspect 46: The method of any of aspects 44-45, where the resource unit allocation or the subchannel mapping is indicated relative to a second primary channel of the second access point.
Aspect 47: The method of any of aspects 44 46, where a resource unit allocated to or a subchannel mapped to the second access point is within an operating bandwidth of the second access point.
Aspect 48: The method of any of aspects 42-47, where receiving the second coordination message includes: receiving, via a resource assigned by the first frame, a response to the first coordination message.
Aspect 49: The method of aspect 48, where the response includes an indication of a second primary channel used by the second access point.
Aspect 50: The method of any of aspects 42-49, where the first frame is indicative of a second primary channel used by the second access point.
Aspect 51: The method of any of aspects 42-50, where the first frame includes a broadcast frame of the coordinated access point procedure.
Aspect 52: The method of any of aspects 42-51, where the first frame indicates the first primary channel and a capability of the first access point.
Aspect 53: The method of any of aspects 41-52, where transmitting the first coordination message includes: transmitting each first coordination message of a plurality of first coordination messages via a different subchannel of a plurality of subchannels of an operating bandwidth of the first access point.
Aspect 54: The method of aspect 53, where the each first coordination message of the plurality of first coordination messages includes a duplicate physical protocol data unit.
Aspect 55: The method of any of aspects 41-54, further comprising: receiving, from the second access point via the first primary channel, a frame that releases at least a portion of the resources of the transmission opportunity.
Aspect 56: The method of aspect 55, where the frame includes a CAS control field comprising fourth information that releases the at least the portion of the resources of the transmission opportunity, where the frame that includes the command and status filed includes a public action management frame, a quality of service Null frame, or a multi-user blockack frame, or a combination thereof.
Aspect 57: The method of any of aspects 41-56, where the first coordination message is indicative of a puncturing pattern associated with the resources; and the first access point communicates with the one or more stations during the transmission opportunity based at least in part on the puncturing pattern.
Aspect 58: The method of any of aspects 41-57, where the second information is indicative of an operating bandwidth of the second access point, a puncturing pattern to be used by the second access point, or both.
Aspect 59: The method of any of aspects 41-58, where transmitting the first coordination message includes: transmitting a control frame comprising the first information or the second information that does not solicit a physical protocol data unit response from at least one second access point of the one or more second access points.
Aspect 60: The method of aspect 59, where the control frame includes a multi-user request to send (MU-RTS) frame or a multi-user block acknowledgement request (MU-BAR).
Aspect 61: The method of any of aspects 41-60, further comprising: communicating with the one or more stations associated with the first access point via one or more resources separate from the transmission opportunity and included in an operating bandwidth used by the first access point to occupy the one or more resources.
Aspect 62: The method of any of aspects 41-61, where the third information is indicative of an operating bandwidth of the second access point, a puncturing pattern to be used by the second access point, or both.
Aspect 63: The method of any of aspects 41-62, where communicating with the one or more stations includes: communicating with the one or more stations that are associated with the first access point during the at least the first portion of the transmission opportunity; and communicating with one or more second stations associated with the second access point during at least a second portion of the transmission opportunity.
Aspect 64: The method of aspect 63, where the at least the first portion of the transmission opportunity and the at least the second portion of the transmission opportunity are a same portion of the transmission opportunity, different portions of the transmission opportunity, or at least partially overlapping portions of the transmission opportunity.
Aspect 65: The method of any of aspects 41-64, where the transmission opportunity is within a target wait time service period (TWT-SP) configured via a first service period.
Aspect 66: The method of aspect 65, where the TWT-SP is associated with a restricted TWT (rTWT) service period that is coordinated with the second access point.
Aspect 67: The method of any of aspects 41-66, further comprising: transmitting, to the second access point, in response to receiving the second coordination message, a third coordination message comprising the second information associated with the allocation of resource association with the coordination, where the first coordination message includes the first information associated with the coordination of the resources.
Aspect 68: The method of any of aspects 41-67, where the second coordination message includes a buffer status report, a clear to send message, a multi-station blockack message, a message carrying buffer status information, a message carrying resource request information, a public management frame, or any combination thereof.
Aspect 69: A method for wireless communications at a first access point, comprising: receiving, from a second access point, a first coordination message comprising at least one of first information associated with coordination of resources of a transmission opportunity or second information associated with allocation of resources associated with the coordination, where the first coordination message includes an indication of a first primary channel of the first access point based at least in part on the first access point and the second access point being configured to use different primary channels; transmitting, to the second access point, a second coordination message comprising third information associated with the coordination of or the allocation of the resources of the transmission opportunity; and communicating with one or more stations during at least a first portion of the transmission opportunity based at least in part on the allocation of the resources.
Aspect 70: The method of aspect 69, where receiving the first coordination message includes: receiving a first frame of a coordinated access point procedure, where the first frame includes the indication of the first primary channel of the second access point.
Aspect 71: The method of aspect 70, where the first frame includes an initial control frame of a C-TDMA procedure.
Aspect 72: The method of any of aspects 70-71, where the first frame includes an allocation of a resource unit to the first access point or a subchannel mapping of a subchannel to the first access point.
Aspect 73: The method of aspect 72, where the resource unit or the subchannel is indicated relative the first primary channel of the first access point.
Aspect 74: The method of any of aspects 72-73, where the resource unit or the subchannel is indicated relative to a second primary channel of the second access point.
Aspect 75: The method of any of aspects 72-74, where the resource unit or the subchannel is within an operating bandwidth of the first access point.
Aspect 76: The method of any of aspects 70-75, where transmitting the second coordination message includes: transmitting, via a resource assigned by the first coordination message, a response to the first coordination message.
Aspect 77: The method of aspect 76, where the response includes an indication of a second primary channel used by the first access point.
Aspect 78: The method of any of aspects 70-77, where the first frame is indicative of a second primary channel used by the first access point.
Aspect 79: The method of any of aspects 70-78, where the first frame includes a broadcast frame of the coordinated access point procedure.
Aspect 80: The method of any of aspects 70-79, where the first frame indicates the first primary channel and a capability of the second access point.
Aspect 81: The method of any of aspects 69-80, where receiving the first coordination message includes: receiving, via a second primary channel of the first access point, a duplicate physical protocol data unit comprising the indication of the first primary channel.
Aspect 82: The method of any of aspects 69-81, further comprising: transmitting, to the second access point via the first primary channel, a frame that releases at least a portion of the resources of the transmission opportunity.
Aspect 83: The method of aspect 82, where the frame includes a CAS control field comprising fourth information that releases the at least the portion of the resources of the transmission opportunity, where the frame that includes the command and status filed includes a public action management frame, a quality of service Null frame, or a multi-user blockack frame, or a combination thereof.
Aspect 84: The method of any of aspects 69-83, where the first coordination message is indicative of a puncturing pattern associated with the resources; and the first access point communicates with the one or more stations during the transmission opportunity based at least in part on the puncturing pattern.
Aspect 85: The method of any of aspects 69-84, where the first coordination message, is indicative of a puncturing pattern associated with the resources; and the first access point communicates with the one or more stations during the transmission opportunity irrespective of the puncturing pattern.
Aspect 86: The method of any of aspects 69-85, where communicating with the one or more stations includes: communicating with the one or more stations during at least the first portion of the transmission opportunity using a puncturing pattern assigned by the first access point.
Aspect 87: The method of any of aspects 69-86, where the second information is indicative of an operating bandwidth of the first access point, a puncturing pattern to be used by the first access point, or both.
Aspect 88: The method of any of aspects 69-87, where receiving the first coordination message includes: receiving a control frame comprising the first information or the second information that does not solicit a physical protocol data unit response from the second access point.
Aspect 89: The method of aspect 88, where the control frame includes a multi-user request to send (MU-RTS) frame or a multi-user block acknowledgement request (MU-BAR).
Aspect 90: The method of any of aspects 69-89, where the third information is indicative of an operating bandwidth of the second access point, a puncturing pattern to be used by the second access point, or both.
Aspect 91: The method of any of aspects 69-90, where communicating with the one or more stations includes: communicating with the one or more stations that are associated with the first access point during the at least the first portion of the transmission opportunity; and communicating with one or more second stations associated with the second access point during at least a second portion of the transmission opportunity.
Aspect 92: The method of aspect 91, where the at least the first portion of the transmission opportunity and the at least the second portion of the transmission opportunity are a same portion of the transmission opportunity, different portions of the transmission opportunity, or at least partially overlapping portions of the transmission opportunity.
Aspect 93: The method of any of aspects 69-92, where the transmission opportunity is within a target wait time service period (TWT-SP) configured via a first service period.
Aspect 94: The method of aspect 93, where the TWT-SP is associated with a restricted TWT (rTWT) service period that is coordinated with the second access point.
Aspect 95: The method of any of aspects 69-94, further comprising: receiving, from the second access point in response to the second coordination message, a third coordination message comprising the second information associated with the allocation of resource association with the coordination, where the first coordination message includes the first information associated with the coordination of the resources.
Aspect 96: The method of any of aspects 69-95, where the second coordination message includes a buffer status report, a clear to send message, a multi-station blockack message, a message carrying buffer status information, a message carrying resource request information, a public management frame, or any combination thereof.
Aspect 97: A first access point for wireless communications, comprising one or more memories storing processor-executable code, and one or more processors coupled with the one or more memories and individually or collectively operable to execute the code to cause the first access point to perform a method of any of aspects 1-20.
Aspect 98: A first access point for wireless communications, comprising at least one means for performing a method of any of aspects 1-20.
Aspect 99: A non-transitory computer-readable medium storing code for wireless communications, the code comprising instructions executable by one or more processors to perform a method of any of aspects 1-20.
Aspect 100: A first access point for wireless communications, comprising one or more memories storing processor-executable code, and one or more processors coupled with the one or more memories and individually or collectively operable to execute the code to cause the first access point to perform a method of any of aspects 21-40.
Aspect 101: A first access point for wireless communications, comprising at least one means for performing a method of any of aspects 21-40.
Aspect 102: A non-transitory computer-readable medium storing code for wireless communications, the code comprising instructions executable by one or more processors to perform a method of any of aspects 21-40.
Aspect 103: A first access point for wireless communications, comprising one or more memories storing processor-executable code, and one or more processors coupled with the one or more memories and individually or collectively operable to execute the code to cause the first access point to perform a method of any of aspects 41-68.
Aspect 104: A first access point for wireless communications, comprising at least one means for performing a method of any of aspects 41-68.
Aspect 105: A non-transitory computer-readable medium storing code for wireless communications, the code comprising instructions executable by one or more processors to perform a method of any of aspects 41-68.
Aspect 106: A first access point for wireless communications, comprising one or more memories storing processor-executable code, and one or more processors coupled with the one or more memories and individually or collectively operable to execute the code to cause the first access point to perform a method of any of aspects 69-96.
Aspect 107: A first access point for wireless communications, comprising at least one means for performing a method of any of aspects 69-96.
Aspect 108: A non-transitory computer-readable medium storing code for wireless communications, the code comprising instructions executable by one or more processors to perform a method of any of aspects 69-96.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first access point, comprising:
a processing system that includes processor circuitry and memory circuitry that stores code, the processing system configured to cause the first access point to:
transmit, to one or more second access points via a primary channel, a first coordination message comprising at least one of first information associated with coordination of resources of a transmission opportunity or second information associated with allocation of resources associated with the coordination;
receive, from a second access point of the one or more second access points, a second coordination message comprising third information associated with the coordination of or the allocation of the resources of the transmission opportunity, wherein the first information or the third information is communicated via the primary channel based at least in part on the first access point and the one or more second access points being configured to use a same primary channel; and
communicate with one or more stations during at least a first portion of the transmission opportunity based at least in part on the allocation of the resources.

2. The first access point of claim 1, wherein, to transmit the first coordination message, the processing system is configured to cause the first access point to:
transmit, via the primary channel, a control frame of a coordinated access point procedure, wherein the control frame comprises the first information.

3. The first access point of claim 2, wherein the control frame is an initial control frame of a coordinated time-division-multiple-access (C-TDMA) procedure.

4. The first access point of claim 1, wherein, to transmit the first coordination message, the processing system is configured to cause the first access point to:
transmit, via the primary channel, a control frame comprising the first information that triggers a physical protocol data unit response by the second access point.

5. The first access point of claim 4, wherein, to receive the second coordination message, the processing system is configured to cause the first access point to:
receive the physical protocol data unit response via a resource unit allocated to the second access point by the first information or the second information.

6. The first access point of claim 4, wherein the control frame comprises a buffer status report trigger frame, and the physical protocol data unit response comprises a buffer status report of the second access point.

7. The first access point of claim 1, wherein, to transmit the first coordination message, the processing system is configured to cause the first access point to:
transmit, via the primary channel, a control frame comprising the first information or the second information that does not solicit a physical protocol data unit response from at least one of the one or more second access points.

8. The first access point of claim 7, wherein the control frame comprises a multi-user request to send (MU-RTS) frame or a multi-user block acknowledgement request (MU-BAR).

9. The first access point of claim 1, wherein, to transmit the first coordination message, the processing system is configured to cause the first access point to:
transmit, via the primary channel, a frame that allocates the resources of the transmission opportunity, wherein the resources are within the primary channel.

10. The first access point of claim 9, wherein the first coordination message transmitted via the primary channel comprises a multi-user request to send (MU-RTS) message or a buffer status report trigger frame.

11. The first access point of claim 9, wherein the first information or the second information comprises a subchannel mapping of each subchannel of a plurality of subchannels to a respective second access point of the one or more second access points.

12. The first access point of claim 11, wherein the plurality of subchannels comprises resources of a radio frequency bandwidth of an operating bandwidth used by the first access point that overlap with resources of one or more second operating bandwidths used by the one or more second access points.

13. The first access point of claim 9, wherein the processing system is further configured to cause the first access point to:
communicate with one or more second stations associated with the first access point via one or more resources separate from the transmission opportunity and included in an operating bandwidth used by the first access point to occupy the one or more resources.

14. The first access point of claim 1, wherein the third information is indicative of an operating bandwidth of the second access point, a puncturing pattern to be used by the second access point, or both.

15. The first access point of claim 1, wherein, to communicate with the one or more stations, the processing system is configured to cause the first access point to:
communicate with the one or more stations that are associated with the first access point during the at least the first portion of the transmission opportunity; and
communicate with one or more second stations associated with the second access point during at least a second portion of the transmission opportunity.

16. The first access point of claim 15, wherein the at least the first portion of the transmission opportunity and the at least the second portion of the transmission opportunity are a same portion of the transmission opportunity, different portions of the transmission opportunity, or at least partially overlapping portions of the transmission opportunity.

17. The first access point of claim 1, wherein the transmission opportunity is within a target wait time service period (TWT-SP) configured via a first service period.

18. The first access point of claim 17, wherein the TWT-SP is associated with a restricted TWT (rTWT) service period that is coordinated with the second access point.

19. The first access point of claim 1, wherein the processing system is further configured to cause the first access point to:
transmit, to the second access point in response to receiving the second coordination message, a third coordination message comprising the second information associated with the allocation of resource association with the coordination, wherein the first coordination message comprises the first information associated with the coordination of the resources.

20. The first access point of claim 1, wherein the second coordination message comprises a buffer status report, a clear to send message, a multi-station blockack message, a message carrying buffer status information, a message carrying resource request information, a public management frame, or any combination thereof.

21. A first access point, comprising:
a processing system that includes processor circuitry and memory circuitry that stores code, the processing system configured to cause the first access point to:
receive, from a second access point via a primary channel of the first access point, a first coordination message comprising at least one of first information associated with coordination of resources of a transmission opportunity or second information associated with allocation of resources associated with the coordination;
transmit, to the second access point, a second coordination message comprising third information associated with the coordination of or the allocation of the resources of the transmission opportunity, wherein the first information or the third information is communicated via the primary channel based at least in part on the first access point and the second access point being configured to use a same primary channel; and
communicate with one or more stations during at least a first portion of the transmission opportunity based at least in part on the allocation of the resources.

22. The first access point of claim 21, wherein, to receive the first coordination message, the processing system is configured to cause the first access point to:
receive, via the primary channel, a control frame of a coordinated access point procedure, wherein the control frame comprises the first information.

23. The first access point of claim 21, wherein, to receive the first coordination message, the processing system is configured to cause the first access point to:
receive, via the primary channel, a control frame comprising the first information that triggers a physical protocol data unit response by the second access point.

24. The first access point of claim 23, wherein, to transmit the second coordination message, the processing system is configured to cause the first access point to:
transmit the physical protocol data unit response via a resource unit allocated to the second access point by the first information.

25. The first access point of claim 21, wherein, to receive the first coordination message, the processing system is configured to cause the first access point to:
receive, via the primary channel, a control frame comprising the first information that does not solicit a physical protocol data unit response from the first access point.

26. The first access point of claim 21, wherein, to receive the first coordination message, the processing system is configured to cause the first access point to:
receive, via the primary channel, a frame that allocates the resources of the transmission opportunity.

27. The first access point of claim 21, wherein:
the second information is indicative of an operating bandwidth of the first access point, a puncturing pattern to be used by the first access point, or both; and
the third information is indicative of an operating bandwidth of the second access point, a puncturing pattern to be used by the second access point, or both.

28. The first access point of claim 21, wherein, to communicate with the one or more stations, the processing system is configured to cause the first access point to:
communicate with the one or more stations that are associated with the first access point during the at least the first portion of the transmission opportunity; and
communicate with one or more second stations associated with the second access point during at least a second portion of the transmission opportunity.

29. A first access point, comprising:
a processing system that includes processor circuitry and memory circuitry that stores code, the processing system configured to cause the first access point to:
transmit, to one or more second access points, a first coordination message comprising at least one of first information associated with coordination of resources of a transmission opportunity or second information associated with allocation of resources associated with the coordination, wherein the first coordination message comprises an indication of a first primary channel of the first access point based at least in part on the first access point and a second access point of the one or more second access points being configured to use different primary channels;
receive, from the second access point of the one or more second access points, a second coordination message comprising third information associated with the coordination of or the allocation of the resources of the transmission opportunity; and
communicate with one or more stations during at least a first portion of the transmission opportunity based at least in part on the allocation of the resources.

30. A first access point, comprising:
a processing system that includes processor circuitry and memory circuitry that stores code, the processing system configured to cause the first access point to:
receive, from a second access point, a first coordination message comprising at least one of first information associated with coordination of resources of a transmission opportunity or second information associated with allocation of resources associated with the coordination, wherein the first coordination message comprises an indication of a first primary channel of the first access point based at least in part on the first access point and the second access point being configured to use different primary channels;
transmit, to the second access point, a second coordination message comprising third information associated with the coordination of or the allocation of the resources of the transmission opportunity; and
communicate with one or more stations during at least a first portion of the transmission opportunity based at least in part on the allocation of the resources.
